(19) United States
(12) Patent Application Publication
(10) Pub. No.: US 2008/0071752 A1
(43) Pub. Date: Mar. 20, 2008

(54) Public relations communication methods and systems

(76) Inventors: Hideyuki Azuma, Newport Beach, CA (US); Tetsuya Suzuki, Tokyo (JP)

Correspondence Address: SMITH, GAMBRELL & RUSSELL, 1130 CONNECTICUT AVENUE, N.W., SUITE 1130, WASHINGTON, DC, 20036, US

(21) Appl. No.: 11/905,145

(22) Filed: Sep. 27, 2007

Related U.S. Application Data
(63) Continuation of application No. 11/004,077, filed on Dec. 6, 2004, now abandoned.
Application No. 11/004,077 is a continuation-in-part of application No. 10/937,356, filed on Sep. 10, 2004.

(51) Int. Cl. G06F 17/30

(52) U.S. Cl. 707/3; 707/E17.108

(57) ABSTRACT

An arrangement for distributing information from Information Providers (IP) to Information Recipients (IR) that utilizes the email system and the Internet to communicate with popular hardware devices—computers, PDAs, cellular phones, etc. IRs receive information anonymously and only the information desired. IPs do not need to “spam” the world in the hope of getting their information into the right hands because it is organized in a manner that allows IRs to receive exactly what they are looking for. Information is provided by an IP to an IR in response to a request from an IR. A PR server organizes and stores information uploaded by IPs, retrieves information requested by an IR and sends an automated response to the IR. A web domain is associated with the PR server provides a common email addressing scheme for communicating between the PR server and the IRs.

### RELATED APPLICATIONS

This application is Continuation-In-Part (CIP) of U.S. application Ser. No. 10/937,356 filed on Sep. 10, 2004 and claims the benefit of the Sep. 10, 2004 filing date for the common subject matter.

### BACKGROUND AND SUMMARY

The way people communicate with each other is changing. More and more people are communicating via their PCs, cellular phones, PDAs, etc. Email and instant messaging are replacing traditional mail. Web-based news is replacing printed newspapers. In the face of such change, a constant in the business world is the need to disseminate marketing and public relations information. There is a need to get relevant information into the hands of a desired target audience. Marketing and public relations must evolve as the manner in which people communicate with each other evolves.

For the purpose of this patent document, consider the world as being divided into Information Providers (IPs) and Information Recipients (IRs). The IPs include businesses that want to advertise their goods or services or otherwise get some kind of information into the hands of a target audience. IRs are those seeking information or who are in a target audience for an IP. For example, an IR might be a young lawyer looking for a sale on a pin stripe who wants to locate a suit purveyor who is running a sale. Or, an IR might be a youngster who likes hamburgers looking for a discount coupon to a local burger hangout.

IPs want to get information into the hands of IRs in an efficient manner. It is inefficient for an IP to email everywhere in the hope of reaching a small subset of people in a desired target audience. That process is not only inefficient, it also breeds ill will among IRs who don't want the information that is being sent to them and consider it to be spam. IRs want to be able to easily get the kind of information they want without sifting though lots of information they don't want. Generally, they also want to protect their anonymity.

Typically, an IR who desires to obtain information from an IP via the Internet has to browse the web pages of each business of the type whose information is sought, or make numerous telephone calls to various businesses to determine which one has a desired item or service. In the case of a web search, an IR must methodically navigate each IP's web page or use a search engine associated with the IP's website in order to locate the information desired. If an IR wants to find all Information of a particular IP, the IR must go to the web pages of that IP to retrieve the information or retrieve contact information for the IP and then send the IP an email or make a telephone call the IP.

An IR has four ways to locate and retrieve desired Information from an IP: 1) use a search engine and follow links associated with numerous “hits” one by one; 2) follow the link of a banner sponsor; 3) choose a program menu choice offered by a carrier, such as a cell phone carrier; and 4) receive and sort through spam mail, junk mail or a magazines.

Such methods are certainly not ideal. Generally, the use of a search engine and clicking on “hits” takes longer than desired. Following the link of a banner sponsor or selecting a menu choice offered by a carrier provides limited information pre-selected by someone else. Even though a banner sponsor may have financial power, it may not be the best choice for a particular consumer. Spam and junk mail are not desired. Approximately 90% of company web pages are useless to the typical IR. Generally people do not know the web address of an organization whose information is sought. It is difficult to find a web address from among the millions of listings in generic search engines.

The inventions described herein generally relate to a comprehensive arrangement in which IPs disseminate information to IRs who want to receive that information—and who actually request the information and receive it anonymously. As a short hand notion, the collection of inventions will be referred to as a “PR system” even though the inventions include systems and methods. The “currency” of the PR system is information. The information is provided by businesses that join the PR system as “members” and become IPs. They store information they want to disseminate in the form of data in a database that is indexed according to various business types, keywords, subjects, geographical locations, etc. IRs who seek information query the database and “hit” information stored by the IPs based on search words that they use in their query. The information sought might relate to marketing, public relations, job openings, discount coupons, sale information, campaign information, company profile, press releases, public announcements, job offers, etc.

Information is not “pushed” onto an IR. Rather, information is only provided by an IP to an IR in response to a request from an IR. An information request may be made by an IR via a web browser interface on the Internet, by sending an email to the PR system, or by sending a text message such as a short message service (SMS) message to the PR system requesting a certain kind of information. Desired information is retrieved from a database of such information provided by IP “members” and sent to the IR making the request.

The arrangements described support various kinds of devices that people use to communicate with each other and to obtain information such as desktop PCs, notebook/laptop computers, cellular devices, PDAs, PHS devices, SMS devices, Blackberry devices, satellite/cable/fiber cable communications systems, Palm devices, hand-held computers, and other data communication devices.

The PR system includes networked servers providing the functions of web server, mail server, domain name server (DNS) and database server. The database server stores information provided by the IP members and disseminates information to the IRs when prompted to do so by a request from an IR. There is at least one web domain associated with the PR server. For example, that domain might be “PRaddress.com”. This domain forms the basis for a common email addressing scheme to be used for communications between the PR server and the IRs. This common address is important because it will become known to IRs and form the basis for various information request messages. By utilizing the common address scheme, an IR is able to access desired information 24 hours a day 365 days a year. An IP can update its information on the PR server at any time via the Internet to allow fast changing information, such as sale information to be disseminated rapidly to IRs. The near universal nature of the arrangements presented herein provide a common ground for businesses, consumers and even governmental agencies to easily communicate with one another. It is a tool that can be utilized by cellular phone carriers, Internet Service Providers (ISP), search engine companies, email companies, etc. An IR that is email capable can send a blank email message, properly addressed, to a PR server and receive an auto reply with desired information contained therein or attached thereto.

Each IP has a number of ways that it can be identified by in IR. Each IR has a number of “aliases” such as a code number, a code name and a company name. Such aliases can be advertised by conventional means such as billboards, posters, TV, radio, etc. so that they become known to potential IRs. For example, a young man looking for a job at an ABC Hamburger shop in New York could simply send a blank email to job@abch.nyc.PRaddress.com and receive, in reply a list of job openings at ABC Hamburger Shops in New York.

It is possible for an IR to access desired information in many ways, not just by knowing a particular alias of a company whose information the IR wants. For example there are search engines available on the PRaddress.com domain for carrying out a generalized search for the type of information desired. IPs affiliate themselves with particular “categories” of organizations, with various “subjects”, and with various “keywords”. All of these facilitate an IR finding desired information and channeling requests for information to the right IPs. As the system evolves, “categories” and “subjects” may change from time to time to keep up with changing needs. Various “categories” and “subjects” can be added and deleted as their popularity changes.

Information uploaded into the PR system by IPs is organized into a plurality of “subjects”. Information pertaining to a particular “subject” such as “job opportunity” can be later retrieved without the need for an IR to wade through lots of irrelevant information not related to job opportunities. IPs can upload information to as many of the “subject” categories as may be relevant to the IPs business. Information on the PR system is accessible by IRs 24 hours a day and 365 days a year through an easy to remember PR address and domain, such as PRaddress.com. As with “categories”, “subjects” can be added and dropped as culture evolves and the popularity of each is continuously assessed.

An IP can be an individual, a business entity or an organization. For example, IPs include commercial business corporations, commercial partnerships, non-profit organizations, religious organizations, charitable organizations, governmental agencies, etc.

IRs can access the PR server through various communication channels and modes of communication. An IR can access via an Internet connection, direct dial up to the PR server, via cellular phone call, etc. IRs are able to receive the contents of PR Information by a return message in response to a message directed to the PR server that includes some “tag” identifying what information is desired, i.e. a “PrCode” number, “PrCode” name, a “subject”, or “category”.

An IR is able to retrieve specific information from a particular IP by using a “PrCode” or other alias associated with that particular IP. Or, the IR can receive information related to a particular “subject” or “category” by using the subject or category name in the information request sent to the PR server. If an IR has access to an Internet web page, formatted either for PC viewing or cellular handset viewing or PDA viewing, the IR can easily search for information by using a directory system including a menu structure or by using a search engine built into PRaddress.com. There is also provided an index of “PrCodes” and names associated with company names. Thus, all that an IR needs to know is a company name to retrieve specific information from that company.

An IR is able to search for information through a variety of communication means and modes and through a variety of ways that the information is organized. The PR system provides a code name and a code number to each IP that becomes a member of the system. These codes can be used by an IR to search for desired information.

Using the principles of the inventions described herein, an IR no longer has to browse the web pages of each IP from which information is sought. With the PR system described in this patent IRs can get information content organized by subject, such as, for example, 16 “subjects”, by sending email without necessarily connecting Internet.

An IR can get all Information contents of 16 “subjects” of an IP if the IR knows a single “PrCode” or “PrName” of that IP. The PR system issues and publishes, at least on-line, a PR address book that includes a “PrCode” (numerical), a “PrName” (alphabetical), a company name and location by city, state and zip code. An IR does not need to search among thousands of web pages and doesn't even need to connect through Internet to find information such as organized into the 16 “subjects” of the PR system.

An IR can utilize the PR address book to find various identifiers for an IP if it knows one or more identifiers. If an IR wants to find all Information of a particular IP, the IR can go to the homepage of the PR system and access the information using various tools including a search engine and a menu navigation system. The PR system is a convenient information source, which allows an IR to make a rather narrow and targeted search. Therefore, in a continuum of PR/marketing tools the PR system somewhere between an Internet homepage and an email/mail magazine.

“PrCodes” can become an identifier of the type that might be printed on a business card handed to someone met during networking. The following are examples of email addresses.
web address: www.abc-humburgershop.com,
email address: peter@abc-humburgershop.com
email address: “PrCode”@10234.PRaddress.com
email address: “PrName”@<ABCH>.PRaddress.com

With common “PrCodes”, both IPs and IRs are able to utilize the PR system anytime and anywhere where wired or wireless connectivity is available.

### BRIEF DESCRIPTION OF DRAWINGS

FIG. 1 is a schematic diagram illustrating a basic concept of the inventions—information providers (IPs) uploading information to a server, storing it in a database and disseminating it to information recipients (IRs).

FIG. 2 is a schematic diagram illustrating that it is possible for IPs and IRs to access and work with the PR system with various hardware devices, communication modes and communication protocols.

FIG. 3 is a matrix showing the variety of device and communication services/protocols available for IPs and IRs having both Internet connection and dial-up direct connection (blocks 210, 212 and 230).

FIG. 4 is a schematic diagram illustrating use of the PR system by a PC/Notebook user with a direct connection such as dial up service.

FIG. 5 is a schematic diagram illustrating concepts relating to information requests via email addressing.

FIG. 6 is a schematic diagram explaining some concepts of the inventions through an illustrative operational example.

FIG. 7 is a schematic diagram showing various “categories” of businesses/organizations into which IP members are organized.

FIG. 8 is a schematic diagram showing various “subjects” of information that can be uploaded and disseminated by IP members.

FIG. 9 is a schematic diagram of the server arrangement for of a presently preferred embodiment of the PR system.

FIG. 10 is a schematic diagram showing the process of a new IP member registering with the PR system.

FIG. 11 is the table definition for the “PRaddress Member Registration” table 1054.

FIG. 12 is the table definition for the “PRaddress Member Delete” table 1055.

FIG. 13 is a schematic diagram explaining how an IP inputs information into the PR system.

FIG. 14 is the table definition for the “PRaddress Information Registration” table 2006.

FIG. 15 is the table definition for the “PRaddress Subjects Registration” table.

FIG. 16 is the table definition for the “PRaddress Information Delete” table 2007.

FIG. 17 is a schematic diagram explaining DNS functions.

FIG. 18 is a schematic diagram showing further interaction between an IP member and the “PRaddress Member Registration” table 1054 and “PRaddress Information Registration” 2006 tables.

FIG. 19 is a schematic diagram showing further interaction between an IP member and the “PRaddress Member Registration” 1054, “PRaddress Information Registration” 2006 and “PRaddress Information Delete” 2007 tables.

FIG. 20 is a schematic diagram showing further interaction between an IP member and the PR system.

FIG. 21 contains the table definition of the “Sponsor Information Registration” table 2028.

FIG. 22 is the table definition for the Sponsor Count Table 2030.

FIG. 23 is a schematic diagram showing interaction between an IR and the “Sponsor Information Registration” table 2028, “Sponsor Count” table 2030, PRaddress Information Registration” table and “PRaddress Subject Registration” table.

FIG. 24 is a schematic diagram showing interaction between an IR and the “Sponsor Information Registration” table 2028 and “Sponsor Count” table 2030.

FIG. 25 is a schematic diagram showing interaction between an IR and the “Sponsor Information Registration” table 2028, “Sponsor Count” table 2030, PRaddress Information Registration” table and “PRaddress Subject Registration” table. It explains how the email search is analyzed.

FIG. 26 is a drawing of a sample home page of PRaddress.com.

FIG. 27 is a schematic diagram illustrating a geographic portion of a navigation menu.

FIG. 28 is a schematic diagram of a form used to register with the PR system to become an IP member.

FIG. 29 is a schematic diagram of a sign in web page for an IP member.

FIG. 30 is a schematic diagram of a web page that acts as a gateway for the IP member.

FIG. 31 is a schematic diagram of PR system web page (PRaddress.com) including a search engine for use by an IR for locating desired information.

FIG. 32 is a schematic diagram of a PR system web page (PRaddress.com) used to search for PR information by “Category”.

FIG. 33 is a schematic diagram of search results shown sub-categories of restaurants in area 806 of FIG. 12.

FIG. 34 is a schematic diagram of a PR system web page (PRaddress.com) used to search for PR information by “subject”.

FIG. 35 is a schematic diagram of search results resulting from a search conducted as shown in FIG. 13.

FIG. 36 is a schematic diagram of a PR system web page (PRaddress.com) used to search for PR information by “subject”.

FIG. 37 is a schematic diagram of a PR system web page (PRaddress.com) used to search for PR information by “subject”.

FIG. 38 is a schematic diagram illustrating use of the PR system by a cellular phone user that does not have an Internet browser built into his cellular phone but does have a text message service available and wants to search by “PR Index/Directory, “Category”, “Subject”, “PrCode”, and “PrName”.

FIG. 39 is a schematic diagram of a web page formatted for a cellular phone user whose phone does have an Internet browser built in to his phone. The cellular user may or may not have access by a direct connection, such as dial up service.

### DETAILED DESCRIPTION

The inventions described herein generally relate to the dissemination of information. The phrase “PR system” is used as a short hand throughout this patent document to collectively refer to various systems, methods and arrangements that allow information providers to get their information into the hands of information recipients who seek that information. These inventions are not limited to “public relations” as the name might imply, but are broader in concept, relating to the dissemination of information of any type. The inventions described and claimed herein apply to both commercial and non-commercial enterprises. The kinds of information being disseminated include, but are not limited to—promotional, public relations, advertising, discount coupons, sale, marketing, jobs, investor relations, etc.

The following definitions are made for the sake of clarity and efficiency.

ISP: Internet Service Provider including any service providing access to the Internet including dial up networks, public networks, private networks, broadband providers, cable providers, satellite providers, fiber optic providers, ADSL, DSL, Dial-up networks, AOL® etc.

PDA: Personal Digital Assistant including Blackberry®, Palm® device, hand held pc, Bluetooth® device, other hand-held wireless device, etc.

Carriers: An entity providing voice and/or data communication from point to point including all cellular systems, cable systems, packet data systems, wire line systems, satellite systems, fiber optic systems, RF systems, dial up dedicated networks, private networks, Internet carriers, PHS, PDA networks, Blackberry® network, AOL® network, etc.

Network: Any arrangement for carrying data among and between any entities attached to the network including satellite networks, fiber optic networks, wired networks, local area networks, wide area networks, broadband wireless networks, etc.

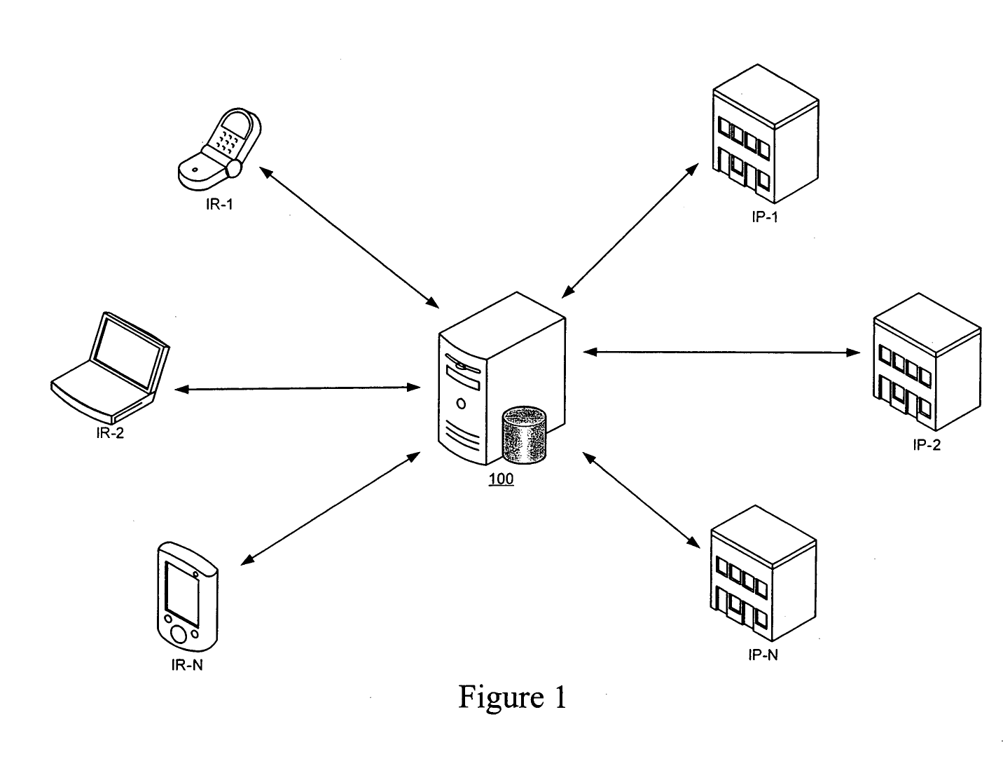

FIG. 1 is a schematic diagram illustrating the core concept of the various inventions that are described and/or claimed herein. The inventions relate in general to systems, methods and arrangements for collecting information from Information Providers (IP-1, IP-2, IP-N), organizing that information in a manner that makes it accessible and searchable, and making that information available to Information Recipients (IR-1, IR-2, IR-N) who seek that information. The term “PR system” refers to the collection of inventions described and/or claimed herein relating to this core concept.

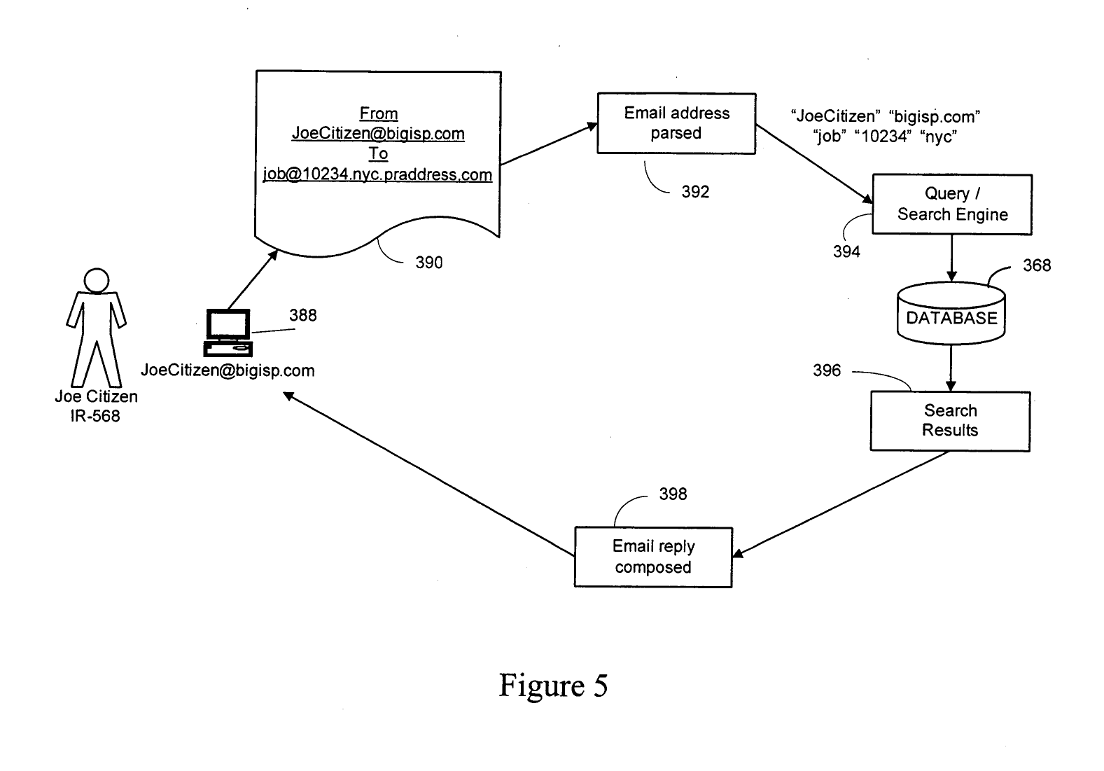

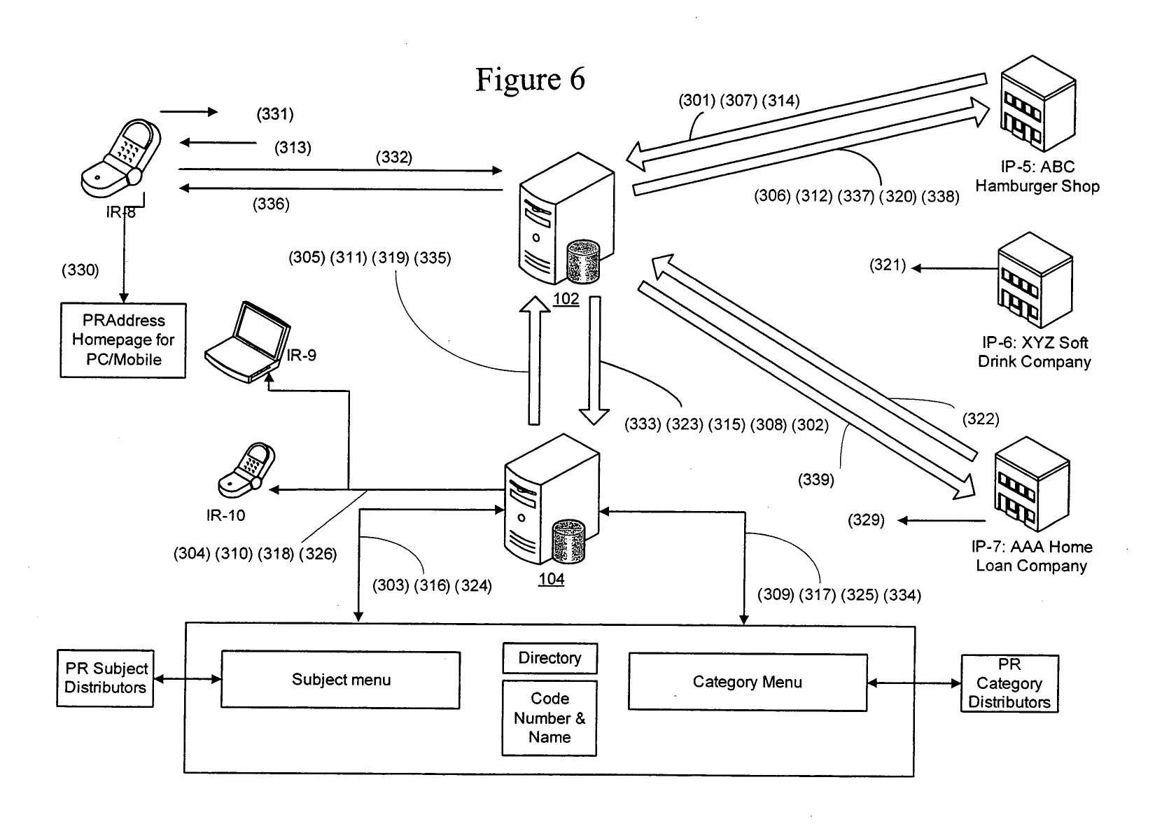

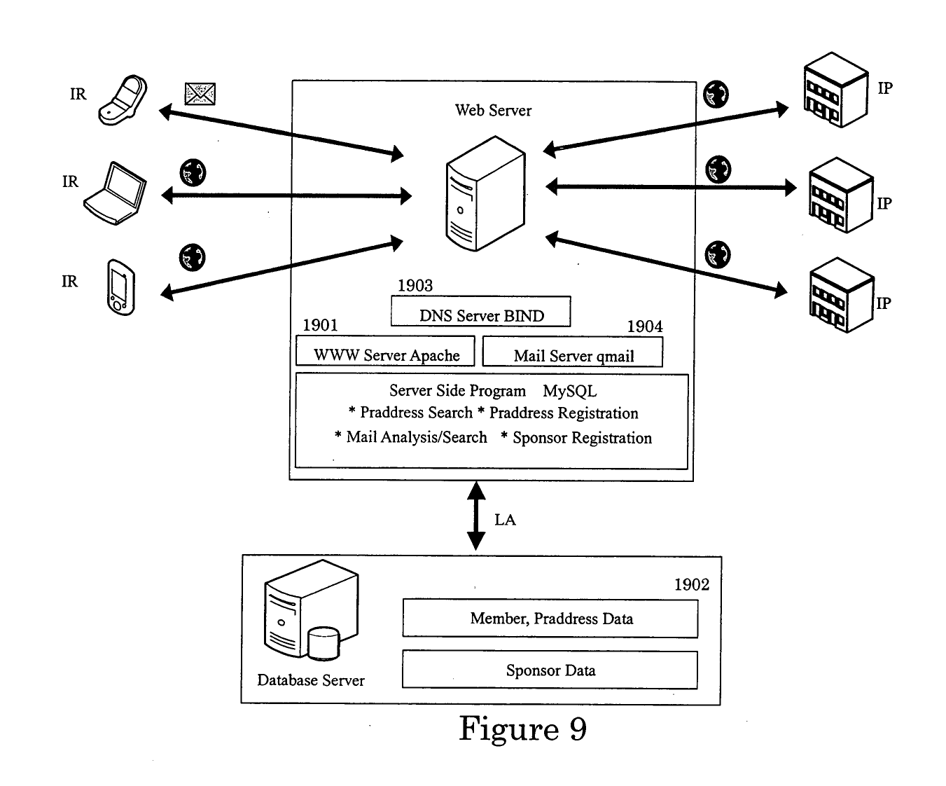

The PR system has a PR server 100 that carries out multiple “server” functions. Although illustrated as a single server in this figure, practical embodiments, such as will be described below, utilize multiple servers appropriately networked to communicate with each other and with IPs and IRs. A two server illustrative example is shown in FIG. 6 and a four server example is shown in FIG. 9. Multiple servers are used in part so that the system is sufficiently robust to handle a large volume of data traffic and communicate effectively with a large number of IPs and IRs. PR server 100 includes hardware and software for carrying out server functions including: database server including a database 368 (FIG. 5), web server, DNS and email server.

Means and methods are provided for communicating in a variety of modes, manners and protocols with both the IPs and the IRs regardless of the types of hardware devices they are using. IR-1, IR-2 and IR-3 are “pictured” and represented in FIG. 1 by a cellular device, a laptop computer and a PDA, respectively to illustrate the universal availability of the PR system to users of different types of devices and communication methods.

A business or organization that wants to disseminate information to others joins the PR system as an “IP member”. An IP member has the right to upload information that is stored in database 368 for distribution to IRs. IRs seeking information make inquiry to the PR system and retrieve information appropriate to their inquiry.

Information uploaded by an IP is stored in database 368 and is organized in part using various organizational features including a “PrCode”, an “EntryNo” corresponding to a “subject”, a “PrName”, a “category”, and various “keywords” that are all available as search terms. Later, inquiries from IRs cause the database to be queried to locate information uploaded by IPs. The query is based in part on these organizational features.

There are various levels of “subscription” available to an IP member. An IP member is permitted to upload and disseminate certain kinds and amounts of information free of charge. Additional information can be uploaded and disseminated for a fee. For example, an IP may be permitted to upload information regarding certain “subjects” but must pay a fee to upload information related to other “subjects”.

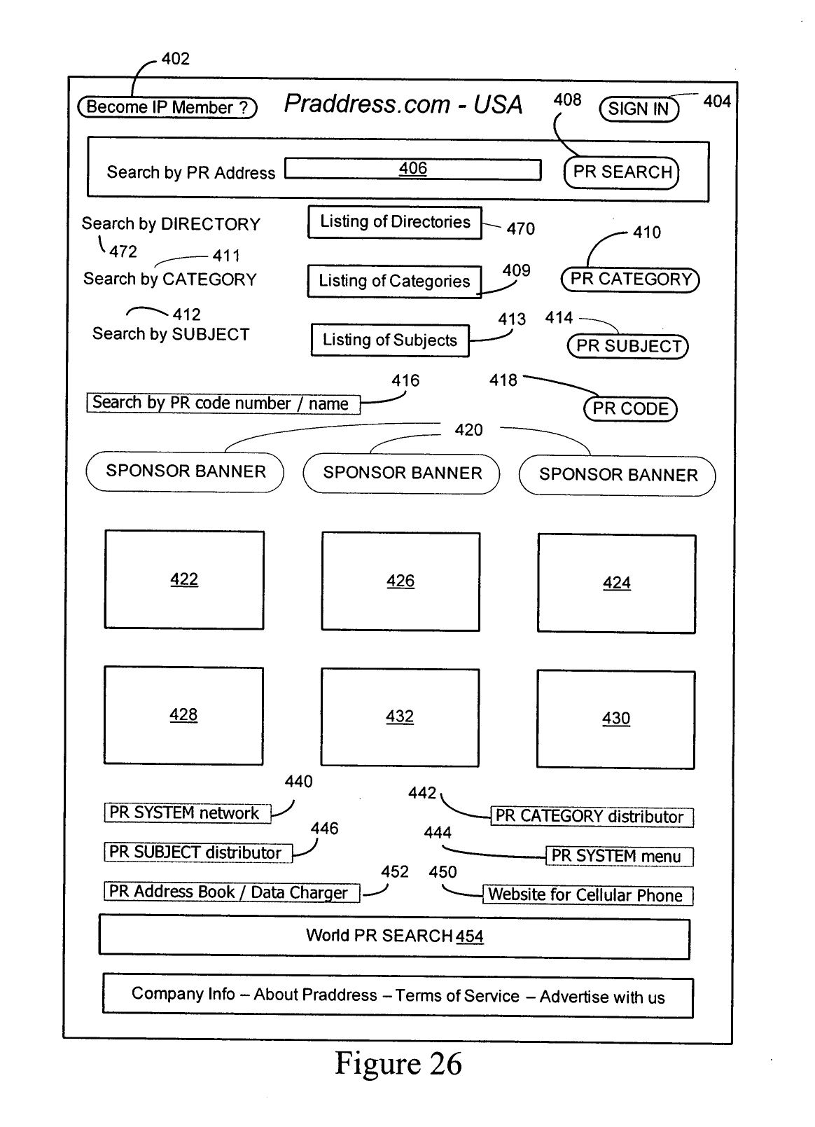

IRs can retrieve stored in the database in several ways: 1) search engine 2) menu navigation system and 3) email system. A web browser interface allows an IR to interact with the PR system in a web environment, i.e. through a series of web pages, such as the home page (FIG. 26). From the web environment, searches can be carried out using a menu system or interactive information boxes and buttons that activate a search engine. To obtain information by email, an IR addresses an email inquiry in a manner that includes search criteria right in the “To” email address. The PR system parses the “To” address and extracts the terms for search. It then reports the search results to the address from which the inquiry came.

In addition to IPs and IRs, there are also “sponsors” including “banner sponsors” and “email sponsors”. “Sponsors” may be IP members but are not necessarily so. There are different kinds of sponsors. A banner sponsor pays a fee to have an advertising banner displayed to an IR receiving search results through a web-based inquiry. An “email sponsor” pays a fee to have an advertising message embedded into an email reply from the PR system to an IR who has made an inquiry by email.

Database 368 organizes information uploaded by IPs into a plurality of tables. The table definitions shown in the drawings and described herein constitute a practical (but not the only) embodiment of the inventions. Many organizations of the database are possible. The specific tables shown are intended to provide one practical example that can be used by others to practice the described and claimed inventions.

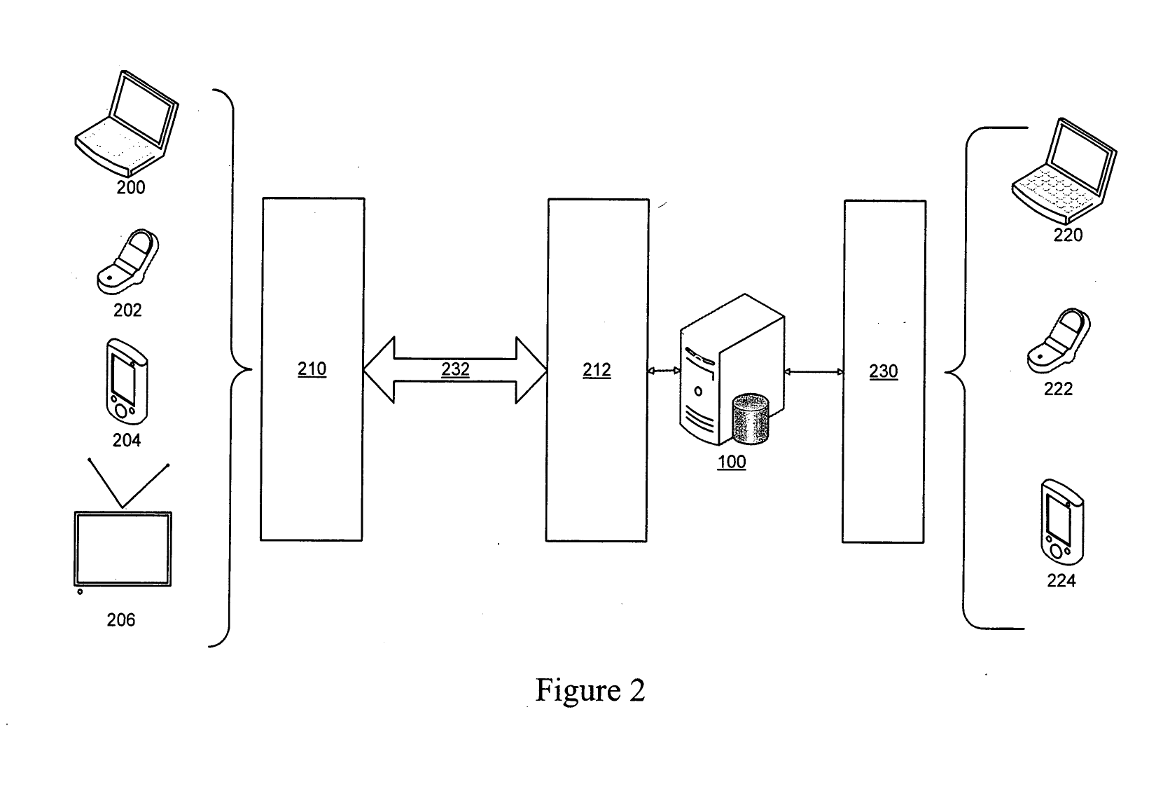

FIG. 2 is a schematic diagram illustrating that it is possible for IPs and IRs to access and work with the PR system using various hardware devices, communication modes and communication protocols. It is intended that the PR system be universally available to IPs and IRs who utilize a range of available communication tools and modes of communication. The PR system provides support that enables IRs to access the PR system using various kinds of devices for data communication including a pc/notebook 200, a cellular device, such as a cellular phone 202, a mobile communication device such as a PDA 204, Palm device, Blackberry, PHS or other portable device, or a television device 206, such as may be part of a cable system, fiber system, satellite system or any digital wireless system. The various devices such as pc/notebook 200, cellular phone 202, PDA 204 and television device 206 gain access through any of multiple types of communication means 210 using various formats/protocols 212.

IPs communicate with PR server 100 using a variety of hardware devices such as a pc/notebook 220, cellular phone 222 or other cellular device, and a PDA 224 or similar device such as a Palm device, Blackberry, PHS device, etc. An IP can communicate with PR server 100 by a variety of communication means 230.

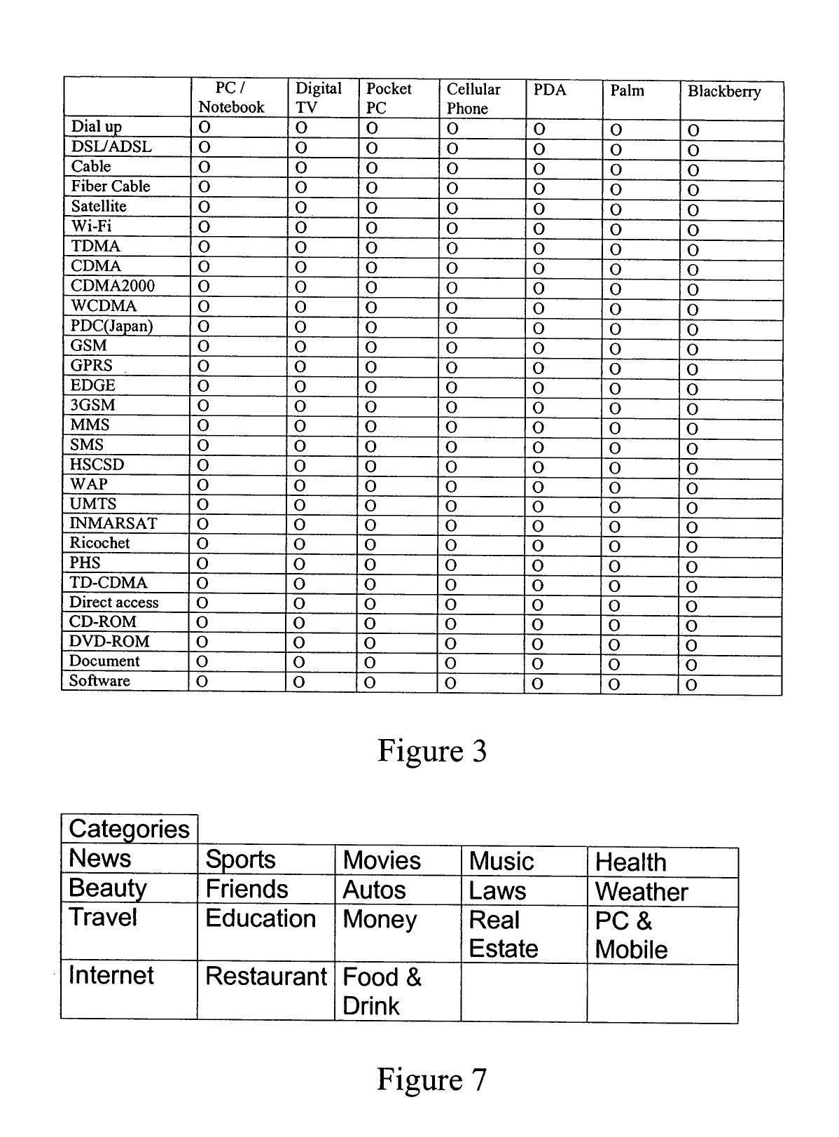

FIG. 3 is a matrix illustrating the variety of devices and communication services/protocols that are supported at the time of this patent document is being prepared. It demonstrates the variety of device and communication services/protocols available for IPs and IRs having both communication means 210, 212 and 230. The list shown in FIG. 3 is a snapshot of what is known today. The infrastructure of communication modes and protocols continues to evolve. As it does, the PR system will continue to evolve as well to provide universal access regardless of user's preferred devices and means of communication.

FIG. 5 is a schematic diagram illustrating concepts relating to information requests via email addressing. An email domain is established, such as, for example, “PRaddress.com” that is associated with the PR system. Emails addressed to this domain are routed to the PR server that carries out search and database functions. A core concept of the email access system is that an IR seeking information sends a blank email message. The “To” address of the email conveys the information needed to query the PR system's database. The information located by the query is returned to the sender of the blank email by an auto reply email system.

A hypothetical example is illustrated in FIG. 5. Joe Citizen, IR-568, is looking for a job in New York City. He would like to work at an ABC Hamburger Shop. Joe Citizen's email address is JoeCitizen@bigisp.com. Joe Citizen uses his computer 388 to send a blank email 390 over the Internet via bigisp.com. The “To” email address is composed in a manner that defines a search to be carried out by the PR system. A portion of the email address (typically the front portion) is coded in a manner that tells PR server 100 what information is desired. In this example a blank email 390 is addressed to: job@10234.nyc.PRaddress.com.

The email is routed through the Internet to the PR system having an Internet domain “PRaddress.com” previously established. The email, when received, is parsed at block 392 to determine what information is sought. This is accomplished in part by email mapping. The “To” address of the email contains various search criteria for locating the desired information. Database 368 is queried by a search engine 394 based on search terms extracted by parsing the “To” email address. In this example, the PR system, at block 392, parses the “To” address of the incoming email and extracts from it pertinent information: “job”, <10234>, and “nyc”.

Search engine 394 carries out a search of database 368. This is accomplished using either an SQL query or text searching. In this example, the query looks for information in database 368 for “PrCode”=<10234> and “Subject”=<Job Offer> that lists a job opening in the geographical area “New York City”. The search locates among the information stored by IP members records related to job openings at various ABC Hamburger Shops in New York. In this example, the PR system retrieves JOB data that is linked with <10234> and “nyc”. Search results are compiled in a process represented by a search results block 396. Information retrieved from database 368 is then incorporated into an auto reply email message that is sent to JoeCitizen@bigisp.com as represented by a block 398. This auto reply email may include banner advertising by an IP who has previously purchased the right to be an email banner sponsor.

FIG. 6 is a schematic diagram explaining various concepts of the inventions through an illustrative operational example. The reference numerals shown in parenthesis such as, for example, (331) represent processes or flows of information. Many such processes or flows of information are represented by the large arrows. Consider a PR system including are three information providers IP-5, IP-6 and IP-7. IP-5 is the ABC Hamburger Shop having a “PrName”=<ABCH>, IP-6 is the XYZ Soft Drink Company, and IP-7 is the AAA Home Loan Company. IP-6 is also an email Banner Sponsor. IP-7 is also homepage banner sponsor. Three IRs: IR-8, IR-9 and IR-10 are symbolized by cell phones (IR-8) and (IR-10) and a PC (IR-9).

The internet domain “PRaddress.com” is established and associated with PR server 100. Of course other domain names can be used. PR server 100 includes a web server function that serves a series of web pages including a home page (FIG. 26) associated with PRaddress.com. These pages are maintained either on a dedicated web domain server or on a shared server. The PR system home page serves as one gateway into the PR system for users including IPs and IRs that have Internet access. The PR system also maintains its own network for direct access, such as for example a dial-up network so that the PR system can be accessed without requiring Internet access.

In this illustrative example, PR server 100 (FIGS. 1 and 2) is shown as two servers, namely PR server 102 and PR server 104 which together carry out all server functions. In preferred embodiments there are a plurality of servers utilized to carry out the various server functions and cope with the data traffic generated by a large number of IPs and IRs. However, for the sake of simplicity of explanation, a two server system is described in this example. PR server 102 functions as a mail server/web server/client server. PR server 104 functions as a database server and contains database 368. It also functions as a directory server, a category server, a subject server, a “PrCode” server, and a “PrName” server. Software loaded onto at least one of the servers includes a search engine having a template for searching information by “PrCode”, “PrName”, “Subject”, “Category”, and “Keyword”. Software is also provided to provide email address parsing and auto-reply for responding to inquiries from IRs that arrive via email.

The home page (FIG. 26) of the PR system's domain (PRaddress.com) includes links for at least the following:
What is PR address?
How to use PR address?
Information Recipient
Information Provider
Banner Sponsor
Partner
System
Frequently Asked Questions (FAQ
IP member LOG IN

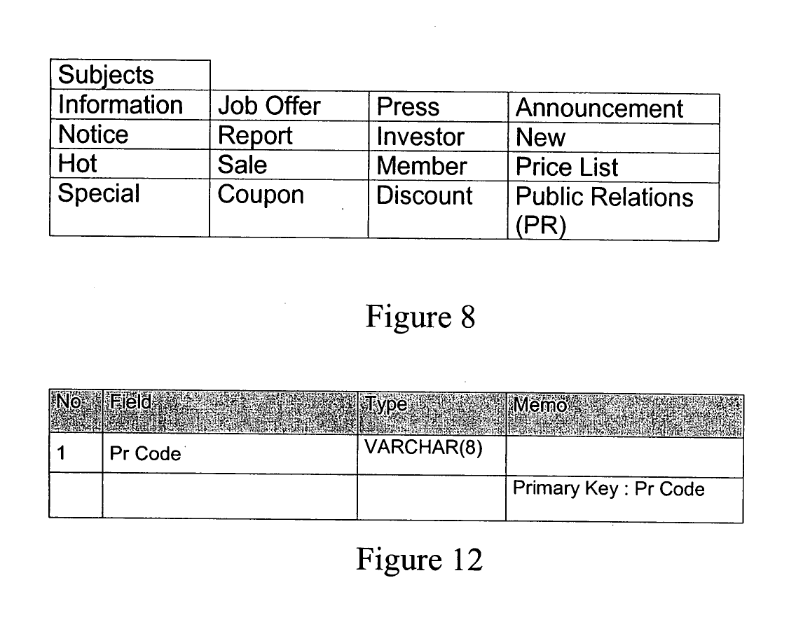

At process 301 a potential IP (to become IP-5 applies, through an online secured CGI form linked from the home page to become an “IP member”. Once IP-5 is a member, he can upload information to be stored in database 368 and distributed to IRs. An IP can select one of eighteen “categories”, shown in FIG. 7, of organizations with which it wants to be grouped. IP-5 chooses to be “categorized” as a “restaurant”. IP-5 uploads information to one or more of sixteen available “subjects”, shown in FIG. 8, as may apply to the business of IP-5. In this example, IP-5 uploads data for the following subjects: <Information> <Notice> and <Job Offer>. In the <Information> subject, IR-5 will upload information about the company. In the <Notice> subject, IR-5 will post public notices. In the <Job Offer> subject, IR-5 will list and then update as needed job openings that it wants to fill.

A potential IP is able to sign up as an IP by pointing a web browser to the home page (FIG. 26) of the PR server domain, but that is not the only way to become an IP member. A potential IP can send a blank email message to register@PRaddress.com and receive by automated email reply an application form that can be used to apply to become an IP member. The email reply includes a links to a web page of PRaddress.com and/or provides a server address for various ISPs, a PR menu, and dial-up (direct access) information.

An IP that is registering with the PR system configures itself to accept an email reply from PRaddress.com by adjusting its spam blocker or other filter accordingly so that emails from the PR system originating at the domain “PRaddress.com” are not blocked. The PR system uses known automated reply email technology that is installed on PR server 102 functioning as an email server.

At process 302 the PR system stores basic information about ABC Hamburger (IP-5) into PR server 104 which maintains the database by setting up records related to ABC Hamburger. The database assigns a “PrCode”, a “PrName” and an initial Password to ABC Hamburger (IP-5). The “PrCode” might be, for example, <10234>. The “PrName” for ABC Hamburger might be, for example, <ABCH>. The “PrCode” and “PrName” can then be used in email addresses created by IRs. Using the exemplary “PrCode” and “PrName”, an email inquiry to the PR system for ABC Hamburger could be addressed to either: “ - - - @10234.PRaddress.com” or “ - - - @abch.PRaddress.com”.

The initial password can be randomly generated or generated according to some predetermined algorithm by PR server 102 and can later be changed by the registered IP member. ABC Hamburger can use the “PrCode” and “PrName” and password to log into a free PR box area of the PR server through the PRaddress.com domain home page when ABC Hamburger wants to upload or update information to be disseminated to inquiring IRs.

At process 303 the database is organized into various “portions”. For example, one portion may be a free content area and other may be a paid content area. Since ABC Hamburger is a registered IP member, ABC Hamburger is able to utilize PR fields dedicated to <Company Info.> <Public Notice> <Job Offer>, etc. and edit its information stored in those areas. All IP members and sponsors will have PR “boxes” to store data related to each “subject”. This information is ultimately stored in appropriate fields of the database. Certain “boxes” can be designated as “free” and others may have a fee associated with their use.

At process 304 PRaddress.com updates by adding Information about ABC Hamburger into the database with an indication that ABC Hamburger is a new IP member. PRaddress.com establishes several type of web pages and a menu top page which are compatible with all popular data communication devices including cellular devices, packet data devices, PDA, SMS, PHS and others, through ISPs and direct access. At process 305 the PR server 104 and PR server 102 reply to ABC Hamburger.

At process 306 ABC Hamburger is informed that “PrCode”=<10234> has been assigned to ABC Hamburger along with “PrName”=<ABCH> and Password “10KyrB89” has been assigned. Other information is also provided to ABC Hamburger, such as for example, <How to use the PR system> <about Paid PR> <about Banner Sponsor> by sending an email to the newly registered IP.

At process 307 ABC Hamburger agrees to pay for PR advertising so that ABC Hamburger can advertise a sale on hamburgers. It opens a SALE box after reading the <Paid PR> information provided by the PR system. The terms of sale in this example includes advertising for a period of one month from Jul. 10 to Aug. 9 of 2004. The specific sale text that will be provided to an inquiring IR will be <$0.50 off any hamburger> <Free drink> <All stores nationwide>. For disseminating this sale ad by email, ABC Hamburger agrees to pay $0.20 per email inquiry from an IR and reply to that IR without counting duplicate email addresses. ABC Hamburger can regularly log into the members area of PRaddress.com and check its statistics to determine in real time the volume of email traffic generated by its sale ad. At process 308 and process 309 the ad text is stored into a PAID PR area of PR server 104 and the appropriate links are stored in appropriate fields of a database table.

At process 310 the PR system updates its data to add the sale information about ABC Hamburger that was just arranged. The information is not only linked with the IP's “PrCode”, “PrName” and company name, but is also classified in a manner that allows an IR using web page or menu access to locate the information by search engine or by navigating through a menu structure. An IR can navigate a menu structure to find desired information by making successive menu choices from a hierarchical menu system. The following is an example with <Sale> at the top of the menu structure.

```
<Sale>
  <Food & Drink>
    <Fast-Food>
      <ABC Hamburger>
```

The following is an example with <Food & Drink> at the top of the menu structure.

```
<Food & Drink>
  <Fast Food>
    <ABC Hamburger>
```

The IR can also search using the search engine by entering one or more keywords, such as, for example, <10234> or <ABCh> into a search engine interactive keyword box. For example, the use of search terms <10234> or <ABCH> would “hit” ABC Hamburger.

At process 311 and process 312 information is sent to ABC Hamburger about setting up <Sale> information. Having registered <Sale> information on the PR system, at process 313 ABC Hamburger will promote and advertise its sale to potential IRs (and all customers) through various means which may include store posters, media advertising (TVs, Magazines, Radios), website advertising, etc. For example, ABC Hamburger may say, for example, on an advertising poster: “Send a blank mail to SALE@10234.PRaddress.com or SALE@abch.PRaddress.com and receive valuable SALE information from ABC Hamburger”. An IR who follows these instructions will receive an auto reply email from the PR system that includes the SALE information.

The PR system can issue a coupon or a voucher with bar code included as an option. It can issue a standard design coupon at no additional charge or an original design coupon for ABC Hamburger for an extra fee depending upon the size and style of graphics desired. When an IR sends an email to the PR server he receives a reply email containing the sale information from ABC Hamburger. The IR could also receive the same SALE information by searching the web using the PR system search engine linked to its homepage (FIG. 26) or using a menu structure available from the PR system homepage. Regardless of how the IR retrieves the sale information, he simply shows it to a clerk at an ABC Hamburger Shop to receive the stated promotional benefit.

At process 314 XYZ Soft Drink Company (IP-6) agrees to purchase some promotion on the PR system. In addition to the normal email reply SALE information described above with respect to ABC Hamburger, XYZ Soft Drink Company also becomes a banner sponsor by paying an extra fee for such advertising. In this case, reply emails to IRs will include a banner advertisement by the XYZ Soft Drink Company. XYZ Soft Drink Company enters into an agreement with the PR system including terms under which a banner will be displayed to an IR. For example, an XYZ Soft Drink Company banner will appear on 10,000 email replies to IR inquiries beginning on Feb. 6, 2005. The banner might read, for example:

<<< Get a free coupon from XYZ drink at http://www.xyzdrink.com >>>

The price of such banner advertising might be, for example, 10,000 emails @$0.15 per each mail. As with ABC Hamburger (IP-5), XYZ Soft Drink Company (IP-6) also can use PR address after being issued a code number, a code name and password.

At process 315 and process 316 the PR system registers XYZ Soft Drink Company as IP-6 and provides a member account for XYZ Soft Drink Company. XYZ Soft Drink Company is given an opportunity to select one of the eighteen (18) “categories” (FIG. 7) of business with which to associate itself. For example, it may select to be categorized as a “FOOD & DRINK” establishment. It is also given the opportunity to upload information to any of the 16 subjects (FIG. 8) that may be applicable.

At process 317 the PR system inputs data and Information of XYZ Soft Drink Company for email banner advertising. The PR system, based on a predetermined algorithm, decides which email responses should include a display of the XYZ Soft Drink Company banner. At the beginning of operation, when the PR system has few members, the XYZ Soft Drink Company email banner will be attached to all email replies. When, on the other hand, there are many members, the PR server will attach the XYZ Soft Drink Company banner to only certain email replies and will select those replies for maximum advantage to XYZ Soft Drink Company, such as, for example, replies relating generally to the category of services provided by XYZ Soft Drink Company, such as drink, food, restaurant and fast food.

At process 318 the PR system updates information of XYZ Soft Drink Company to indicate that it is a new IP member. At process 319 and process 320 the PR system provides a “PrCode”, a “PrName” and a randomly selected Password to be associated with XYZ Soft Drink Company. For example the “PrCode” <4118> is assigned and the “PrName” <xyzsd> is assigned. Later, an IR will be able to send an email to “ - - - @4118.PRaddress.com” or to “ - - - @xyzsd.PRaddress.com” and receive a reply including the sale information of XYZ Soft Drink Company. After the XYZ Soft Drink Company has established its membership status, it can change its password; update its company information, select and make changes to “category” and “subjects”, etc. by logging onto the PR system web page at PRaddress.com. It can also check its performance statistics when desired. These statistics will include the number of email replies and other retrievals of information and the number of email banners displayed.

At process 321 XYZ Soft Dink Company promotes and advertises how to access its information uploaded to the PR system. It may do so through the use of conventional media such as posters, media advertising (TV, magazines, radios, websites, etc). The sale advice provided in this conventional media can simply be:

< Send a blank email to coupon@4118.PRaddress.com or to
coupon@xyzsd.PRaddress.com and receive a valuable coupon
issued by XYZ Soft Drink Company. >

The PR system can issue a standard coupon or a voucher or a special design coupon or voucher with or without a bar code and with or without an infrared code. Extra fees may apply for special coupons. An IR using a cell phone or PDA with a small screen may be able to only receive a simple text file. Information sent to IRs is appropriately sized for the kind of device the IR is using to access the PR system. Coupons and other information provided by the PR system will be formatted in various ways to be compatible with all types of hardware to provide universal access.

At process 322 AAA Home Loan Company agrees to become a member and also agrees to purchase top banner PR advertising on the PRaddress.com homepage. It becomes IP-7. AAA Home Loan Company enters into an agreement with the PR system for a 3 month term for a fee of $1,000 per month. A banner to be displayed on the home page of PRaddress.com might read:

< Get 7.5% Home Loan at http://www.AAAhomeloan.com>

When AAA Home Loan Company joins the PR system, it is issued a code number, a code name and an initial password. At process 323 and process 324 the PR system registers AAA Home Loan Company as IP member IP-8 and opens an account for AAA Home Loan Company. The AAA Home Loan Company is then given access to select subject and categories under which it would like to be listed for menu and search purposes. In this example, the AAA Home Loan Company affiliates itself with the category of “money”. This affiliation is “marked” by the proper entry in the “category” field of the IP-8 record in the database.

At process 325 the PR system inputs data and information related to AAA Home Loan Company and programs an advertising banner for display at the top of the PRaddress.com homepage. Early in its operation, when there are few IP members, the banner of AAA Home Loan Company may be displayed frequently. As the number of IP members grows, the top banner space may be shared with others in some kind of sequence or priority. As an alternative, the banner may be displayed as a “flash” banner for an extra fee.

At process 326 the information about AAA Home Loan Company is stored. The PR system issues a “PrCode”, a “PrName” and an initial Password for AAA Home Loan Company. For example the “PrCode” assigned is <5005> and the “PrName” assigned is <aaahl>. Thus, the PR addresses of AAA Home Loan Company will be “ - - - @5005.PRaddress.com” and “ - - - @aaahl.PRaddress.com”. AAA Home Loan Company can use those 2 PR addresses immediately. AAA Home Loan Company can log into the members area of PRaddress.com and make a “category” selection and upload information to various “subjects” so that IR users can easily find the information of AAA Home Loan Company by menu selection and by the use of the search engine. AAA Home Loan Company can check its performance statistics when desired.

At process 329 AAA Home Loan Company promotes and advertises how to access its new PR address to its potential customers through posters, business cards, catalogues, media advertisings (TV, magazines, radio), and on the AAA Home Loan Company website. Through these conventional media, AAA Home Loan Company advises to potential customers to

< Send a blank mail to PR@5005.PRaddress.com or
PR@aaahl.PRaddress.com and get valuable Information from
AAA Home Loan>

At process 330 IRs are learning about the PR system and about PRaddress.com solution through Internet, search engines, magazines, etc. At process 331 IRs are also getting to know about PR solution by advertisings from IPs and banner sponsors.

At process 332 IR-8 learns a PR address of ABC Hamburger that is promoting a coupon for <$0.50 off Hamburger, free Fizzy Soda at any ABC for a limited time October 10th-November 9>. The IR sends email to <sale@abch.PRaddress.com> or to <sale@10234.PRaddress.com> in order to receive an auto reply email containing the promotional coupon.

At process 333 and process 334 the PR system parses the addressee portion of the email and obtains the search terms “sale” and <ABCH> or “sale” and <10234> depending on which email address was used. This parsed information is then used to query the database in PR server 104 and retrieve the sale information associated with ABC Hamburger from the appropriate field or fields of data. The retrieved data is incorporated into a reply email at process 335 which is sent via email auto-reply software at process 336 to IR-8. This email includes an email banner from email banner sponsor XYZ Soft Dink Company (IP-6). The email reply may be a fully formatted email or a text message depending upon equipment and communication method used by IR-8. The email message content is: <$0.50 off any Hamburger, Free Fizzy Soda>.

The reply email which the IR receives has a banner advertisement of XYZ Soft Drink Company—also in the text file. The IR takes the email to any ABC Hamburger Shop and shows it to a clerk to obtain the advertised benefit. If the IR feels uncomfortable to send his initial email inquiry from a proper email address, he can make a second/transfer email from the PRaddress.com homepage or can use one of the many free anonymous email systems such as yahoo mail or hotmail. An IR can get many other valuable coupons and other information by accessing the PR system through its website—PRaddress.com either via the Internet or via a direct dial-up connection.

At process 337 PRaddress.com provides a performance report during the term of its agreement to ABC hamburger Shop. At process 338 PRaddress.com provides a performance report to XYZ Soft Drink Company. At process 339 PRaddress.com provides a performance report to AAA Home Loan Company. The PR system described by way of this example is available to potential customers (IRs) so that they can receive information from a variety of businesses and business types. IRs can locate and retrieve desired information while providing or not providing their identity to avoid any privacy issues.

The example depicted in FIG. 6 is an example written mainly to illustrate Internet access to the PR system because the Internet is likely to be a common way to access. However, users without Internet access can also use the PR system by direct access (including dial-up) without using Internet. There are two ways to make direct access to the PR system without utilizing the Internet:
Dial-up with PR service access point; and
Access via a service menu of a carrier.

Many carriers and other data communication carriers now offer “service menus” that are accessed via a phone number or some other access. Examples of such service menus include “i-mode”®service offered via NTT DoCoMo and “T-zone” service offered by T-Mobile. Services with such service menus are actually systems run on servers typically that are directly accessed via a carrier user. Such service providers can enter into agreements with the PR system to link to the PR system in such a manner that the PR system can become a service menu item on such systems.

FIG. 9 is a schematic diagram of the server arrangement for of a presently preferred embodiment of the PR system. In FIG. 1, the PR server functions were all represented by a PR server 100 for the sake of simplicity in describing basic functions of the PR system. In practical embodiments the PR system, server functions are carried out by a plurality of servers running conventional operating systems and basic applications software for performing their respective server functions. The various servers can be directly coupled to one another or can be coupled to one another through a local area network (LAN) or even a wide are network (WAN).

Web server 1901 is an Apache web server running on a Linux operating system (OS) platform. It serves the various web pages of the PR system including the home page shown in FIG. 26. Database server 1902 runs on a Windows OS platform and runs the application “MySQL”. Database server 1902 stores and operates database 368 which includes a plurality of tables described below. It receives uploaded information from IPs, maintains database 368, and provides information from the database in response to inquiries.

Database server 1902 maintains database 368 which holds information about IP members and sponsors. A presently preferred (at the time of this writing) embodiment of the hardware/database/software arrangement for implementing the inventions described/claimed herein utilizes an Apache database server running “MySQL” on a Windows OS. Of course there are many possible ways to implement these inventions. MySQL is presently preferred because of its fast process speed and its compatibility with a Google search engine. The database includes various database tables which are described below.

The DNS 1903 runs on a Linux OS platform and runs BIND software. It performs all required domain name functions. Mail server 1904 runs on a Linux OS platform and runs the “Qmail” application for performing mail server functions. “Qmail” is the preferred choice at the time of this writing because it is able to create needed mail accounts without user information input.

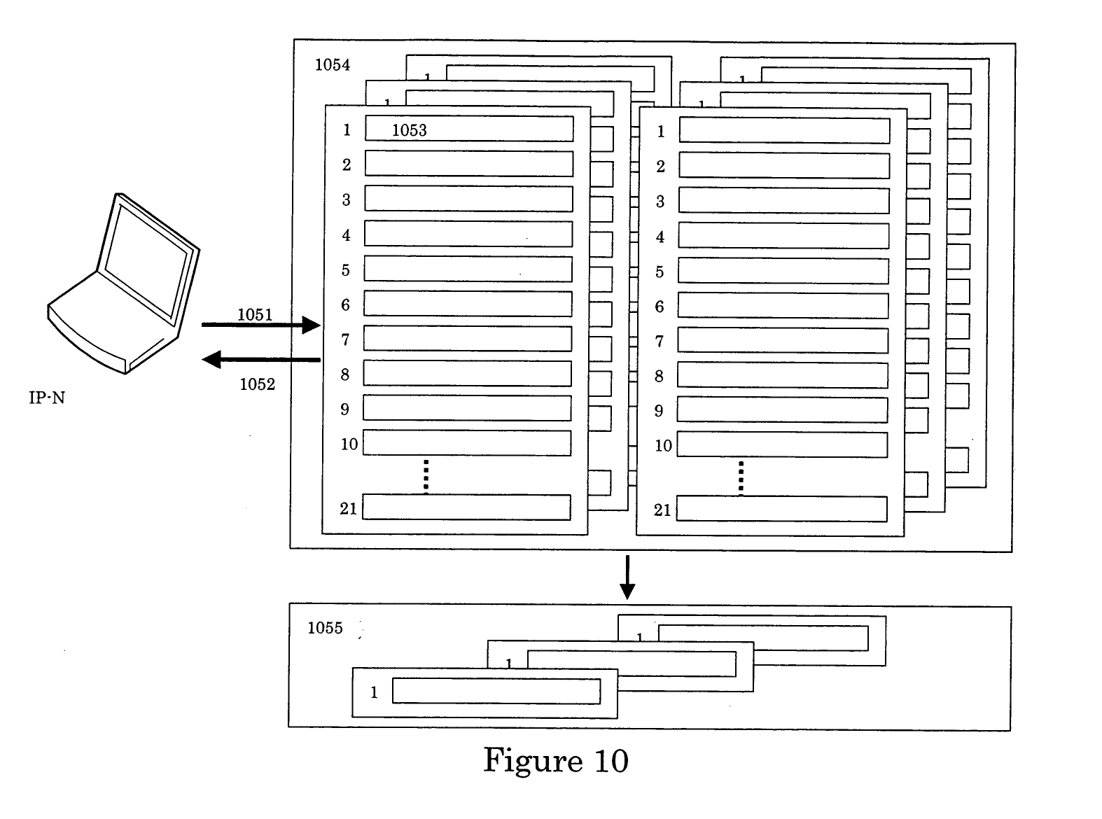

FIG. 10 is a schematic diagram showing the process of a new user registering with the PR system to become a new IP member IP-N. A new IP member can register and upload information a registration webpage template. A link to this template is located on the home page (FIG. 26) of the PR system. The new user clicks on a “registration” button to begin the process of entering data. Reference numeral 1051 denotes the input of information by the new IP member. Template displays and confirmation/error messages are signified by reference numeral 1052.

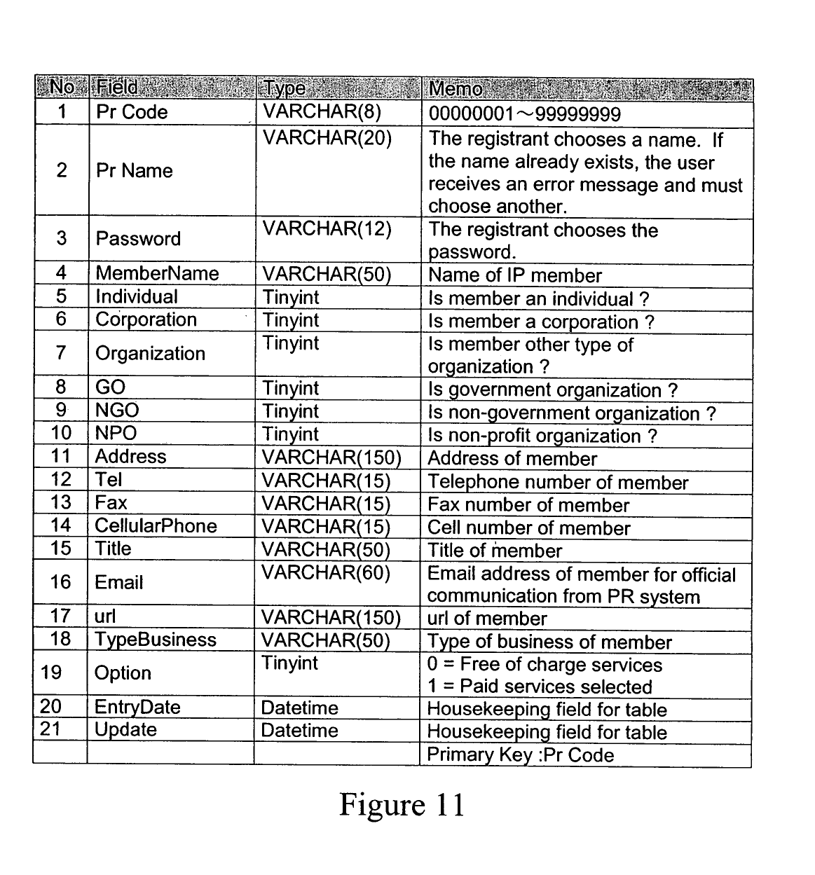

A new IP member first uploads general data to be stored in the “PRaddress Member Registration” table 1054. Several records of the “PRaddress Member Registration” table 1054 are shown in FIG. 10, each record being represented by 21 fields of information. A complete table definition of the “PRaddress Member Registration” table 1054 is shown in FIG. 11.

During the new IP member registration process, IP member information input via the registration template is stored in appropriate fields of the “PRaddress Member Registration” table 1054 (FIG. 11). During the registration process the new IP member selects a “PrName” which is, in effect, an alias that identifies the IP member. The database server checks to determine if the “PrName” selected by the new member is already in use by another member. If so, an error message is displayed to the new IP member asking him to select another “PrName”. The new IP member selects a password following predetermined guidelines.

The PR system automatically generates a “PrCode” for the new IP member. This “PrCode” will be stored in the appropriate field of the “PRaddress Member Registration” table 1054 and is represented by reference numeral 1053. The “PrCode” is a unique code comprising eight digits. The system keeps track of these codes already issued so that there is no duplication. A “PrCode” deleted from the “PRaddress Member Registration” table 1054 because an IP member leaves the PR system is stored in the “PRaddress Member Delete” table 1055 (see table definition in FIG. 12) to be recycled after a predetermined period of time (like a phone number).

Generally “PrCodes” are assigned serially. The next new code is equal to the previously created code +1. The “PrCode” is generated from the right most (least significant) digit and is filled with leading zeros. “PrCodes” range from 00000001-99999999. When the new member has been fully registered, a record in the “PRaddress Member Registration” table (FIG. 11) is created and appropriately indexed.

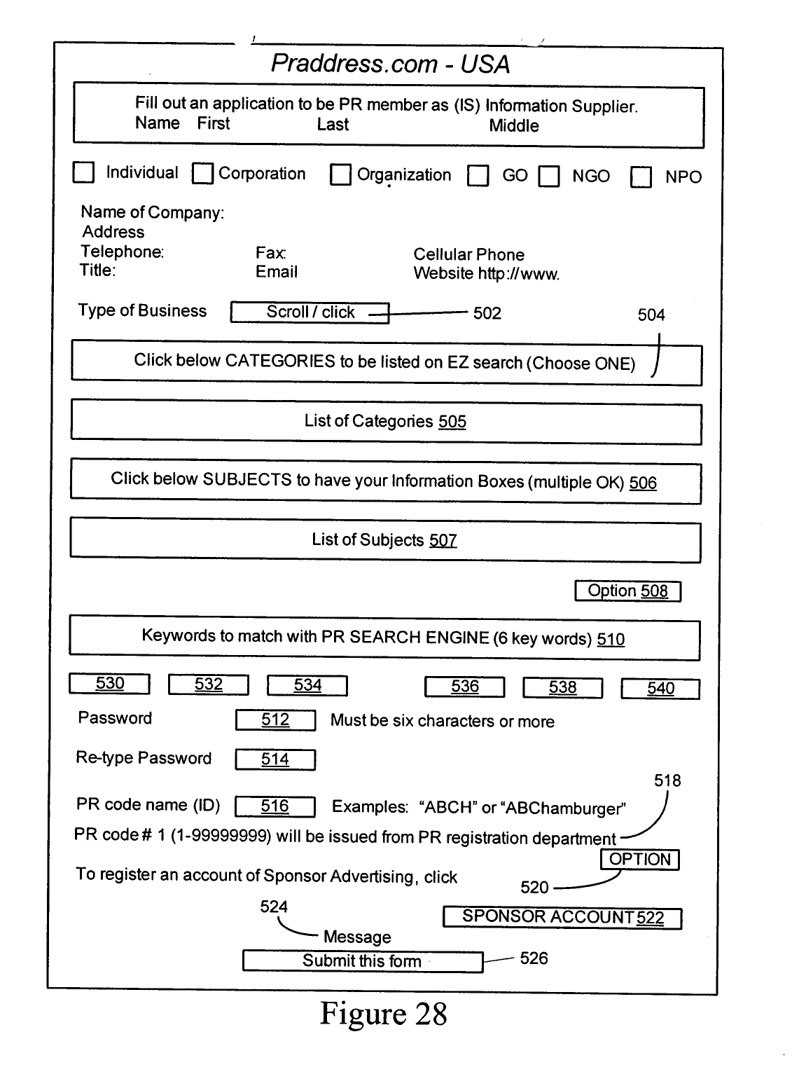

An IP who has already registered (completed the initial registration process) and entered basic data into the “PRaddress Member Registration” table 1054 can, at any time, sign into the PR system by clicking a SIGN IN button at the home page of the PR system website (PRaddress.com) shown in FIG. 26. The IP member is linked to a user log in page (FIG. 28). At that page, the IP member can input his “PrCode” and “Password” to gain access to his PR Information.

FIG. 11 sets forth the table definition of the “PRaddress Member Registration” table 1054. Each of the table definitions includes a reference for each field a field number, a field name, an indicator of the type of database field and a memo including any comment or further description about the field. The tables are written in a common form known to those who develop databases. For all table definitions, the number of characters that can be input into each field is specified. The PR system supports the most popular Western and Asian languages. For those languages using two-byte codes (such as for example, Chinese, Korean and Japanese), the number of characters that can be stored in a particular field is half the number of characters described in table definition. Thus, 50 characters can be entered in a field defined by VARCHAR (100) when using one of the languages that uses two-byte codes.

When a new IP member joins the PR system, he enters basic data describing the new IP member through a template. The data is stored in this table. Each record of this table has twenty one fields of data. The registration process is the first step required to utilize the system as an IP. During the registration process the new member acquires a “PrCode” “Pr Name” and “Password”. When registering, a new IP can select his own “PrName” and password. “PrNames” in the system are unique. Therefore, if the initially selected “PrName” is already in use, the new member will receive an error message and will be forced to select a different “Pr name”. The PR system assigns the “PrCode”, which is also unique for each member.

The “PrCode” is stored in field #1, the “PrName” is stored in field #2, and an initial “Password” is stored in field #3, etc. A complete listing of fields is shown in the figure. The password can be changed by the IP as desired. Other IP member information, such as member name, type of organization, location, contact information, type of business, service options selected, etc. are also obtained from the new IP member during registration and are stored in appropriate fields of data in the “PRaddress Member Registration” table 1054.

FIG. 12 is the table definition for the “PRaddress Member Delete” table 1055. As the PR system is used and evolves, members will come and go. When an IP member leaves the PR system, the associated “PRcode” is at least temporarily “retired” and stored in the “PRaddress Member Delete” table 1055. The code may later be assigned to a new IP member in much the same manner as a telephone number is recycled after a period of time has passed.

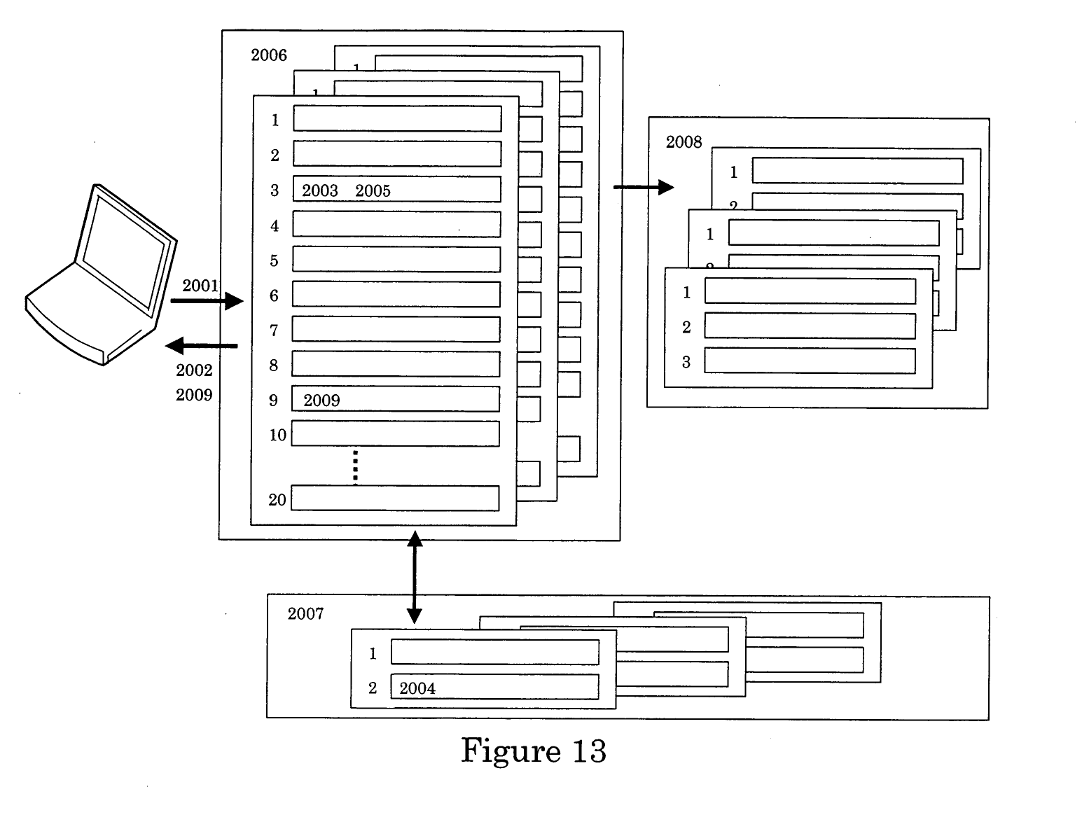

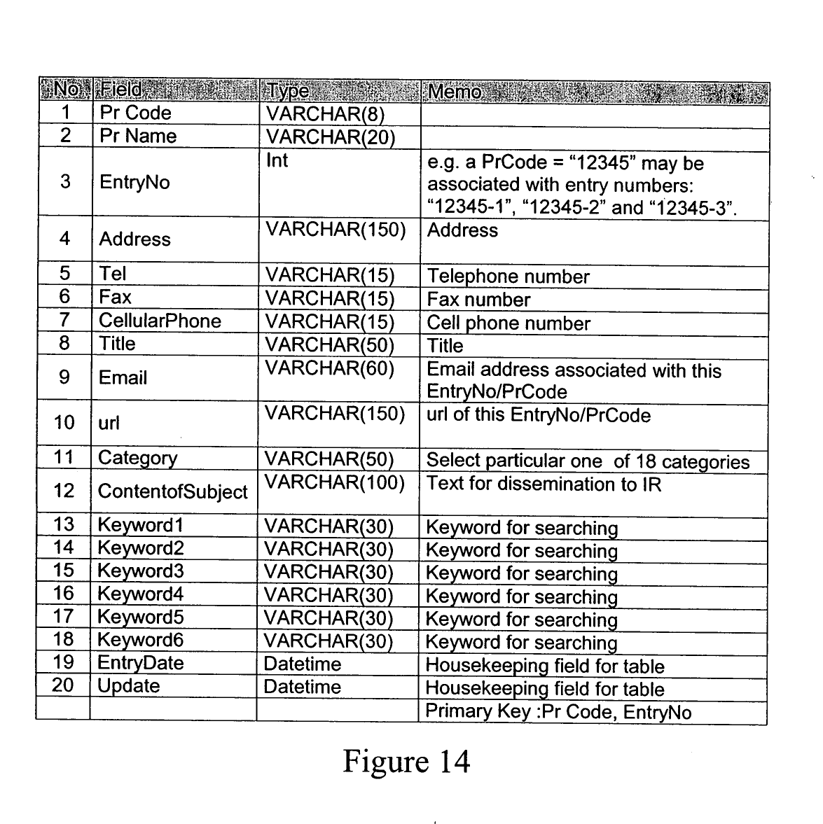

FIG. 13 is a schematic diagram explaining about PR Information Registration. In general, inputs of information by the IP are represented by reference numeral 2001 and displays to the IP are represented by reference numeral 2002. The figure describes interaction of an IP member with the “PRaddress Information Registration” table 2006, the “PRaddress Subjects Registration” table 2008, and the “PRaddress Information Delete” table 2007. Before further describing this process, the three relevant tables will be described. The table definitions for those tables will be described immediately below with respect to FIGS. 14, 15 and 16.

FIG. 14 is the table definition for the “PRaddress Information Registration” table 2006. This is the table that stores various organizational features that are searched in response to an inquiry from an IR. The table includes twenty fields of data. These fields of data include various fields of data containing contact information as in the “member registration table”. The table also includes a “Category” field for storing information defining the type of business or organization of the IP, a “ContentofSubject” field and six key word fields (“Keyword1” . . . “Keyword6”). The “EntryDate” and “Update” fields are used for database housekeeping. They keep track of the creation and updating of database entries.

The “ContentofSubject” field contains the information that will be disseminated to an IR who has made inquiry. For example, for a discount coupon stored in a record relating to the “Discount” subject, the field “ContentofSubject” might include the following: <50% OFF sale of selected items. Sale starts June 1 and runs until June 9>.

An IP member can have more than one “EntryNo” corresponding to respective “subjects”. Thus, there can be more than one record in the “PRaddress information registration table” corresponding to a single IP member record in the “PRaddress Member Registration” table 1054.

When an IP member enters data describing his organization he selects one of the eighteen “categories” (FIG. 7) that best describes his organization based on a broad categorization of organizations. The category selected is stored in the “Category” field of the “PRaddress Information Registration” table 2006. An information request by an IR that is limited to a particular “Category” will only identify IPs that have self selected to be affiliated with that particular category.

The information stored in this table is searched when an IR is trying to find information related to an IP. An IR's search terms is used to query fields such as “keyword”, “PrCode”, “Category”, etc. These queries generate “hits” by the search engine if text stored in one of these fields matches a search term used by an IR looking for information. Each IP Member having a “PrCode” and “PrName” can have multiple “EntryNos”. A certain number of these “EntryNos” are provided for free (option=0). Additional “EntryNos” require payment (option=1). “EntryNos” correspond to various types of information to be provided by a particular IP Member. For example, ABC Hamburger Shop has “PrCode”=“0000456” and “PrName”=<ABCH>. It may have five different records in the PRaddress table corresponding to entry numbers:
0000456-1 (job information)
0000456-2 (discount coupon)
0000456-3 (location information)
0000456-4 (nutritional information)
0000456-5 (suggested recipe).

Each “EntryNo” relates to a particular “subject”. These subjects can be searched by IRs looking for information. When an IR searches based on a particular “subject”, all EntryNos. that are associated with that particular “subject” will present a “hit” to the IR who is searching. The following describes a “PRaddress Subjects Table” which stores subjects that are associated with the various “PrCode” and “EntryNo”.

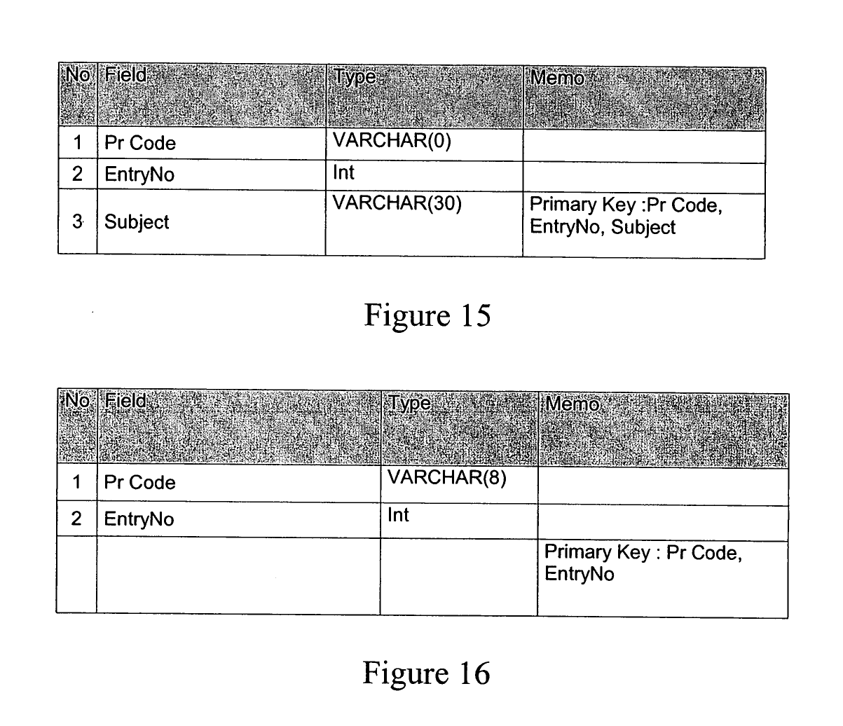

FIG. 15 is the table definition for the “PRaddress Subjects Registration” table 2008. An IP can associate a “PrCode” with a plurality of “subjects” (FIG. 8), corresponding to “EntryNos”. Thus, for each record described by a “PrCode” in the “PRaddress Information Registration” table 2006 there can be a plurality of records in the “PRaddress Subjects Registration” table 2008. An IP can upload information pertaining to one or more of these “subjects”, as desired. The table entries guide a search to the information stored by an IP member that is associated with a particular subject. The classifications of “Category” and “ContentofSubject” are flexible and may change from time to time. As culture changes, “category”, “ContentofSubject”, and “Subject” will go out of favor and others will take their places. Information that is in common between the PRaddress Subjects Registration” table 2008 and the “PRaddress Information Registration” table 2006 are synchronized.

FIG. 16 contains the table definition of the “PRaddress Information Delete” table 2007. This table preserves a deleted “EntryNo” when information registered in the “PRaddress Information Registration” table 2006 is deleted.

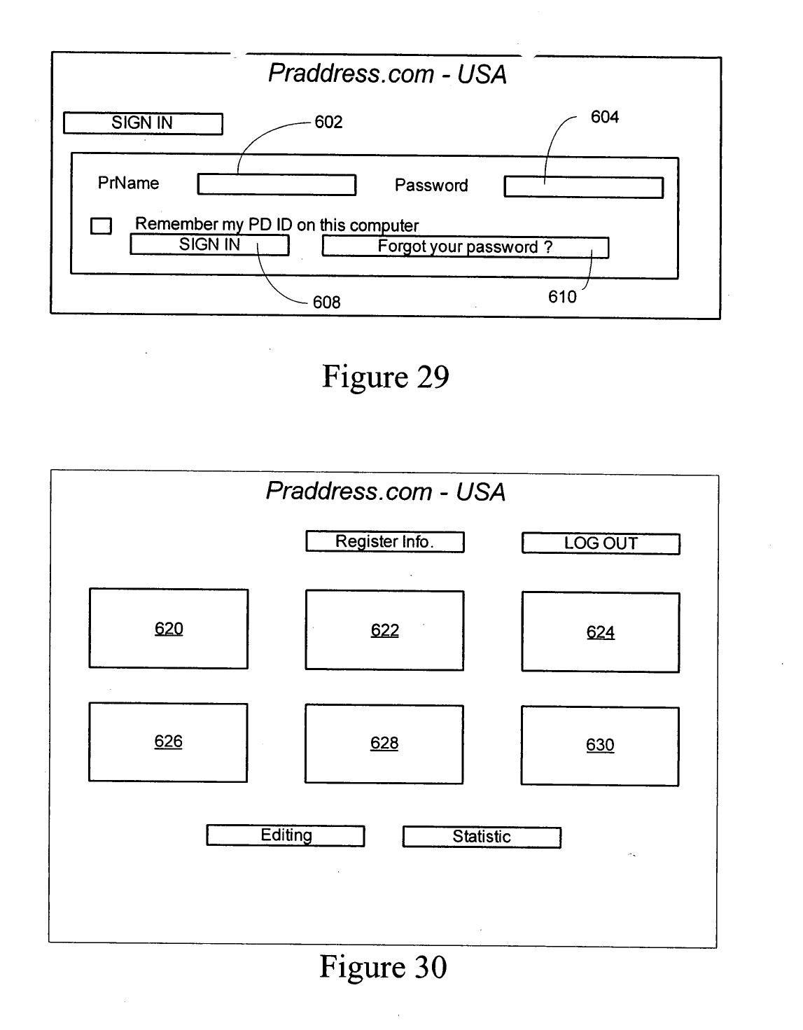

Referring again to FIG. 13, there is illustrated the process by which an IP member registers with the PR system, and uploads information to be stored in database 368 for later dissemination. An IP member accesses the IP member LOG IN page (FIG. 29) by clicking the SIGN IN link on the home page (FIG. 26). The IP member inputs his “PRcode” and “Password” to log in and then gains access to a PR Information Registration page. The IP member inputs PR Information directly and clicks on the registration button in the PR Information Registration page. Content entered by the IP into a template is uploaded to database 368 and the information is linked to the “PRaddress Information Registration” table 2006.

When the option field of the “PRaddress Member Registration” table 1054 is “0”, an IP member is able to register PR Information for up to five “EntryNos” (corresponding to five subjects free of charge. “EntryNos” are related to “PrCodes” in the sense that each “EntryNo” has the same root as its corresponding “PrCode” and also has an additional extension, such as “−1”, “−2”, “−3”, “−4”, “−5”. “EntryNos” correspond to various “subjects” of information that an IP member is providing through the PR system, such as, for example, job information, discount coupons, etc. If the IP member tries to register a sixth category of information through an additional “EntryNo”, he will receive an invitation to subscribe to additional services. A subscription would result in the option field being changed to

Entry Nos. are generated by the system according to predetermined rules. From time to time, a PR member will want to delete an “EntryNo” because it no longer wants to convey information related to the subject corresponding to that “EntryNo”. Deleted “EntryNos” are stored in the “PRaddress Information Delete” table 2007 so that they can be reassigned as needed in the future, when a PR member wants to add a new subject of information. Generally, an “EntryNo” is assigned from smallest available to largest. When an “EntryNo” that had been previously stored in the “PRaddress Information Delete” table 2007, is activated the data of the activated “EntryNo” is deleted from the “PRaddress Information Delete” table 2007, as represented by reference numeral 2004.

The “PRaddress Information Delete” table 2007 acquires the largest number of “EntryNo” as represented by reference numeral 2005. When an “EntryNo” does not exist in the “PRaddress Information Delete” table 2007 the “EntryNo” is automatically assigned by selecting the next larger entry number after the highest in use. Each “EntryNo” has a corresponding record in the “PRaddress Information Registration” table 2006. An inquiry from an IR that includes a “PrCode” or “EntryNo” will locate each record containing such number.

FIG. 13 also shows the input of information into the “PRaddress Subjects Registration” table 2008. The content of PR information input by an IP member is automatically registered in both “PRaddress Information Registration” table 2006 and the “PRaddress Subjects Registration” table 2008 simultaneously when the IP member inputs PR Information and clicks the registration button on the PR Information Registration page. Thus, the number of records in the “PRaddress Subjects Registration” table 2008 is the same number as the number of “EntryNo” records in the “PRaddress Information Registration” table 2006.

The confirmation of the registered content of the Member Registration and PR Information is represented by reference numeral 2009. A successful registration of a new IP member and the uploading of information to database 368 triggers an auto reply confirmation email sent to the email address that is stored in the “Email” field of the “PRaddress Member Registration” table 1054.

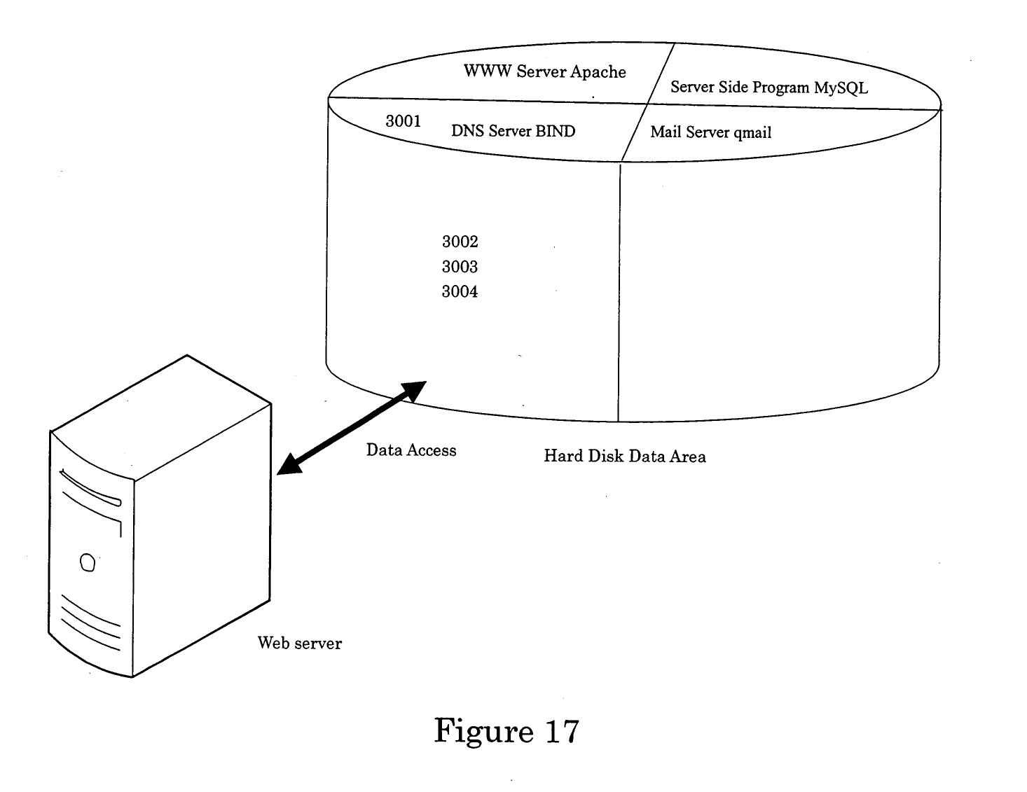

FIG. 17 is a schematic diagram explaining various server functions. At 3001, an IP member registers his private email address with the DNS. This private email address is stored in the “PRaddress Member Registration” table 1054 of database 368 (field 16, FIG. 11) and is used by the PR system to communicate official business to the IP member.

One of the ways that an IR seeks and retrieves information from the PR system is by sending an email query to the PR system (FIG. 5). The IR sends a blank email to the domain of the PR system (PRaddress.com). Various portions of the email “To” address contain terms that define a search to retrieve data of interest to the IR. The email address is “parsed” to extract various terms to be searched. This is accomplished in part by email address mapping in the email server.

At 3002, content of certain fields of data are copied from the database tables of database 368 and used to map incoming emails. The following relates to the registration of the DNS. This data includes “PrCode”, “state”, the domain of the PR system (PRaddress.com), and “PrName”. At 3004, the mail server updates a zone file of PRaddress.com. The mail server can then appropriately direct incoming mail inquiries containing these pieces of data as part of the “To” address sent to the PR system. For example,
???? IN PTR [Pr Name].[state].PRaddress.com
???? IN PTR [PrCode].[state].PRaddress.com
   “????” represents the IP address of the server of PRaddress.com (FIG. 17).

The following describes the mapping that occurs in the mail server for mapping transmissions at 3004. The “BIND” software running on the DNS maps incoming email so that the various component parts of an email address can be used to locate the data sought by an IR. For example, see the following mappings.

[subject] @[PrCode].[state].PRaddress.com → search@PRaddress.com
[subject] @[Pr Name].[state].PRaddress.com → search@PRaddress.com

An IR can address an email query by using any of the “subjects” that are in use. The user composes a blank message with a “To” address assembled by concatenating various search terms. The address begins with the [subject]. Then the “@” sign is added. After the “@” sign, the IR completes composing the email query by typing the [PrCode], [state] and adding the domain [PRaddress.com]. There is an email mapping set in the DNS for each “subject” available as stored in the “PRaddress Subjects Registration” table 2008. By setting the same number for the “Subjects” and the data which is registered in “PRaddress Subject Registration” table, the email sent for each “subject], “PrCode] and “state] of subject@prcode.state.PRaddress.com can be received at search@PRaddress.com and can be a search processing the received email.

From time to time, IP members need to correct or change their associated data. Correction and change requires updating information stored in various fields of the database tables, such as the “Member Registration” table 1054 and the “PRaddress Information Registration” table 2006. An IP member accesses the IP member LOG IN page (FIG. 29) and clicks a “SIGN IN” interactive button on the home page (FIG. 26). The IP member inputs his “PrCode” and “Password” via an interactive process accessed via the LOG IN page and clicks SIGN IN. The IP member is “recognized” if there is a matched association of data for “PrCode” and “Password”. Once logged in, the IP member is able to make changes and corrections to the various fields of data stored and associated with him in the “PRaddress Member Registration” table 1054 and “PRaddress Information Registration” table 2006.

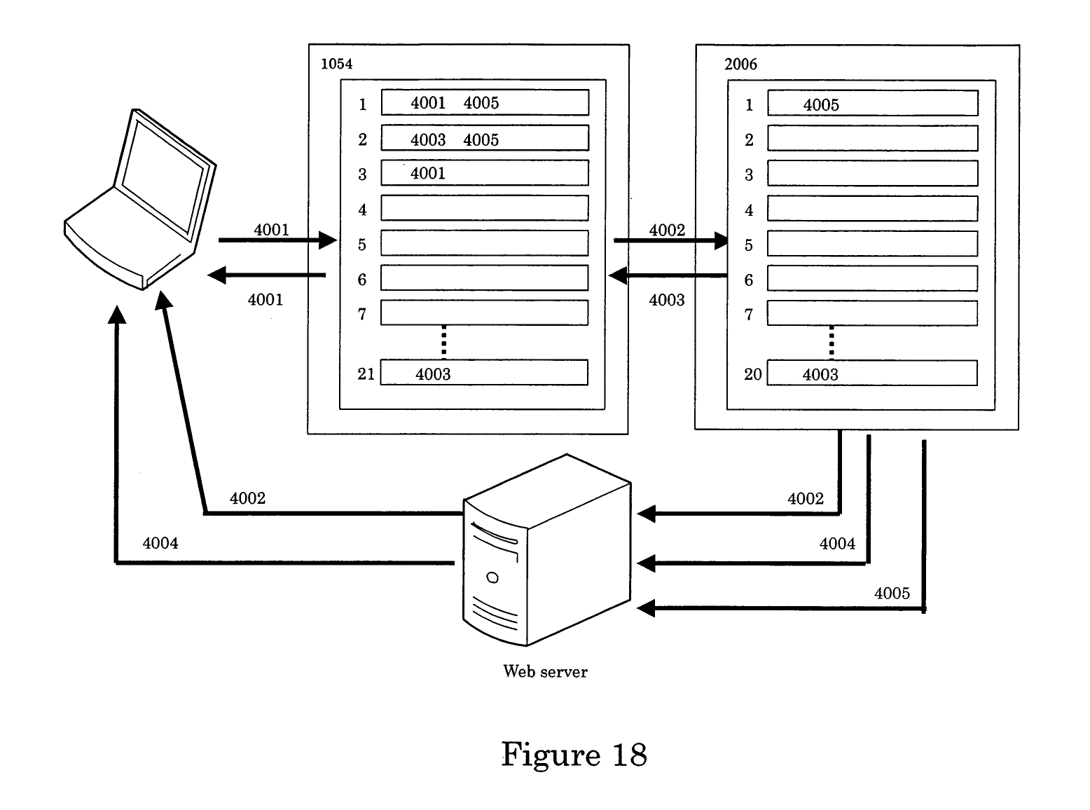

FIG. 18 is a schematic diagram showing further interaction 4001 between an IP member and the “PRaddress Member Registration” 1054 and “PRaddress Information Registration” 2006 tables. If someone attempts to log in as an IP member and neither the “PrCode” nor “Password” input can be found in the “PRaddress Member Registration Table”, an error message is displayed to the user indicating that either the “PrCode” and/or “Password” is wrong. The IP member is permitted to SIGN IN only when he inputs a valid “PrCode” and “Password” combination as set forth in the “PRaddress Member Registration” table 1054.

After an IP member completes the sign in process, the content of the “PRaddress Member Registration” table 1054 and “PRaddress Information Registration” table 2006 associated with the IP member are displayed for review 4002. The IP member can correct the information content of “PRaddress Member Registration” table 1054 and “PRaddress Information Registration” table 2006. When an IP member wants to add/change/delete “Pr Name”, a new “Pr Name” is searched from the data in “PRaddress Member Registration” table 1054 to determine availability a desired name. An IP member is not permitted to use a “PR Name” already in use. An error message is displayed if there is an attempt to adopt a “Pr Name” already in use. The IP member is encouraged to try another “Pr Name”.

The contents of correction of “PRaddress Member Registration” table 1054 and “PRaddress Information Registration” table 2006 are preserved automatically when registered. At 4003, the date and the time of Update of the “PRaddress Member Registration” table 1054 (field 21, FIG. 11) and “PRaddress Information Registration” table 2006 (field 20, FIG. 14) that the IP member has corrected is set and synchronized with the date and the time of the server system.

At 4004, an IP member can check and confirm the corrected contents of the “PRaddress Member Registration” table 1054 and “PRaddress Information Registration” table 2006 by auto transmitting (sending email message to the registered email address of the IP member after clicking the “Registration” button. At 4005, when an IP member changes “Pr Name” or “state” in “PRaddress Member Registration” table 1054 and “PRaddress Information Registration” table 2006, the setting of the DNS and the mail server are changed and reset along with the content of a new “Pr Name” or “state” automatically by the server program. When an IP member changes the information of “Pr Name” or “state”, the DNS does the following;
1 deletes [PrCode].“state].PRaddress.com and [PrName].[state].PRaddress.com
2 register a new [PrCode].[state].PRaddress.com and [PrName].[state].PRaddress.com
   The content to setting “Pr Name” or “state” is the same as the first registration.

When an IP member changes the information of “Pr Name” or “state”, the contents of registration in the mail server are changed as follows;
1 deletes [PrCode].[state].PRaddress.com and [PrName].[state].PRaddress.com
2—register a new [PrCode].[state].PRaddress.com and [PrName].[state].PRaddress.com
   The content to setting “Pr Name” or “state” is the same as the first registration.

There is a procedure to delete content registered in the “PRaddress Information Registration” table 2006. An IP member accesses the IP member LOG IN page (FIG. 29) and clicks SIGN IN on the home page (FIG. 26). The member inputs his “PrCode” and “Password” in the IP member LOG IN page and clicks SIGN IN. The IP member is recognized to LOG IN when “PrCode” and “Password” are matched with the data of “PRaddress Information Registration” table 2006. The IP member is then able to delete the data which is registered in the “PRaddress Information Registration” table 2006 after attestation as an IP member.

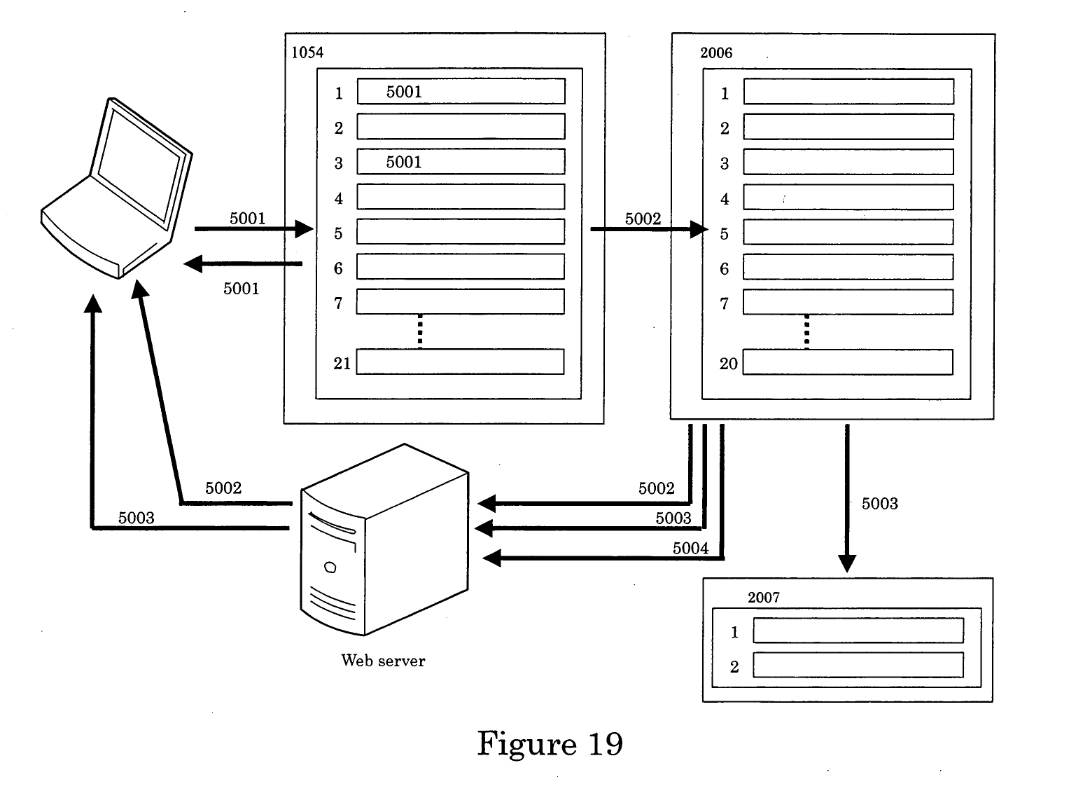

FIG. 19 is a schematic diagram showing further interaction between an IP member and the “PRaddress Member Registration” 1054, “PRaddress Information Registration” 2006 and “PRaddress Information Delete” 2007 tables. At 5001 when neither the “PrCode” nor the “Password” which the IP member input exists in data of “PRaddress Member Registration” table 1054, an error message is displayed, such as, for example, “PrCode and Password is wrong” and the member is not permitted to sign in. The IP member is permitted to SIGN IN when “PrCode” and “Password” are the same as the data in “PRaddress Member Registration” table 1054. After SIGN IN, the content of “PRaddress Member Registration” table 1054 and “PRaddress Information Registration” table 2006 which are registered by the IP member's “PrCode” are displayed on the screen at 5002.

At 5003, the IP member can delete the contents of “PRaddress Information Registration” table 2006. When the IP member deletes content previously registered and stored in “PRaddress Information Registration” table 2006, the data corresponding to “EntryNo” of “PRaddress Information Registration” table 2006 and “PRaddress Subjects Registration” table 2008 is deleted and preserved by automatically storing it in the “EntryNo” field of the “PRaddress Information Delete” table 2007. An IP member can check and confirm the deleted contents of “PRaddress Information Registration” table 2006 by the auto transmitting (sending email message at the registered email address of the IP member after clicking the “Delete” button.

At 5004, when the IP member deletes the Information from the “PRaddress Member Registration” table 1054 and “PRaddress Information Delete” table 2007, the setting of the DNS and the mail server are deleted by the server program with the automatically.

A member can delete content registered in the PRaddress Member Registration Table after logging in. The IP member accesses the IP member LOG IN page (FIG. 29) and clicks SIGN IN (FIG. 26) from the top page of the PRaddress Website. The IP member input “PrCode” and “Password” in the IP member LOG IN page and clicks SIGN IN. The IP member is recognized to LOG IN when “PrCode” and “Password” are matched with the data of “PRaddress Information Registration” table 2006. The IP member is then able to delete the data which is registered in “PRaddress Member Registration” table 1054 and “PRaddress Information Registration” table 2006 after the attestation as IP member.

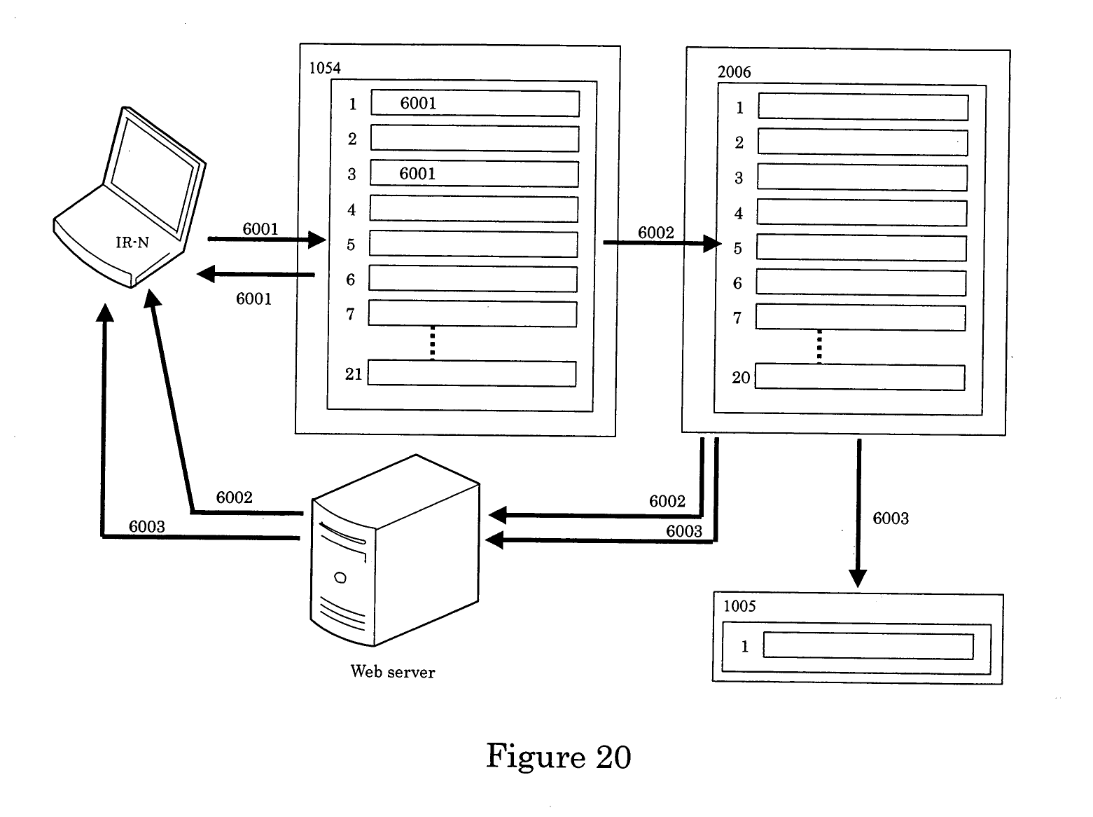

FIG. 20 is a schematic diagram showing further interaction between an IP member and the PR system. At 6001, when neither the “PrCode” nor the “Password” input by a user exist in the “PRaddress Member Registration” table 1054, an error message is displayed, such as, for example: “PrCode and Password are wrong”. In such case, the user is not permitted to sign in.

An IP member is permitted to SIGN IN when “PrCode” and “Password” are the same as data found in the “PRaddress Member Registration” table 1054. After SIGN IN, the content of “PRaddress Member Registration” table 1054 and “PRaddress Information Registration” table 2006 which are registered by the IP member's “PrCode” are displayed on the screen at 6002.

At 6003, the IP member can delete the contents of his associated record of the “PRaddress Member Registration” table 1054. When the IP member deletes content from the displayed record, the “PrCode” corresponding to that record is deleted and preserved in the “PrCode” field of the “PRaddress Member Delete” table 1055 automatically.

The IP member can check and confirm the deleted Information of “PRaddress Member Registration” table 1054 by the auto sending an email message at the registered email address of the IP member after clicking the “Delete” button.

An IR seeking information can do so by initiating a keyword search using either the search engine template provided on a web page of PRaddress.com or by sending an email to the “PRaddress.com” domain with the keywords built into the “To” address of the email. Keywords and other information stored in the “PRaddress Information Registration” table 2006 are searched based on keywords entered by the IR. These keywords may find various hits among the plurality of IPs in the PR system. The content of the search hits are then displayed to the IR conducting the search. The IR inputs a search condition relating to the content desired and clicks the appropriate interactive button to transmit the search request to the PR system. The PR system queries the “PRaddress Information Registration” table 2006 to determine if any of the search criteria correspond to any data stored in the appropriate fields: “Category”, “ContentofSubject”, “PrCode”, “Pr Name”, “State”, “City”, “Zip code”, “keyword1”, “keyword2”, “keyword3”, “keyword4”, “keyword5”, and “keyword6”.

If the IR inputs two or more search conditions trying to narrow down the number of hits, the search result should be highly targeted. For example, assume that an IR searches using three keywords such as “job” <10234> and “nyc” by sending an email to the following email address: job@10234.nyc.PRaddress.com

Through domain email mapping and other software techniques, the PR system parses the email query and extracts search terms to check for in the various database tables. The system will look for “PrCode” or “Pr Name” that are stored in the “PRaddress Information Registration” table 2006 based on the <10234> portion of the email address.

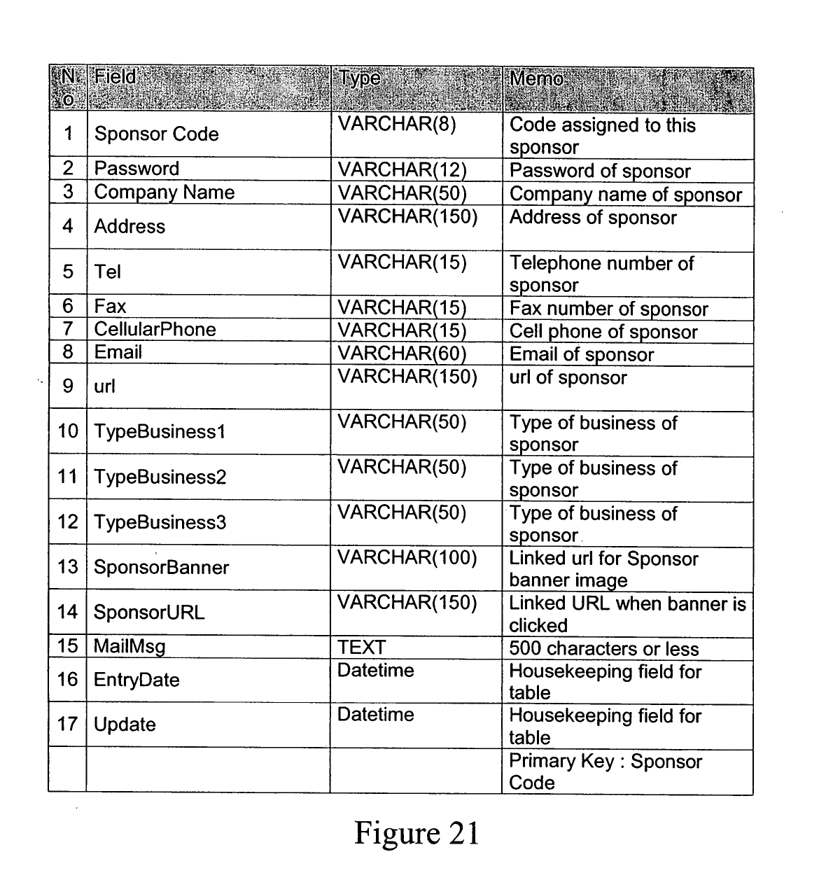

FIG. 21 contains the table definition of the “Sponsor Information Registration” table 2028. The “Sponsor Information Registration” table 2028 is a table that registers information about sponsors. A private and/or a corporate sponsor of banner advertising and/or text advertising for “Web site”, “Information Search Result page”, and “Return mail of Information Result report” of PRaddress register their advertising material such as “Banner material”, “URL linked with the banner”, and “Text message” besides Information of a private and/or a corporate sponsors. The advertising sponsors can check and confirm the delivery information data and the number of accesses of advertisements by using registered “Sponsor Code” and “Password”.

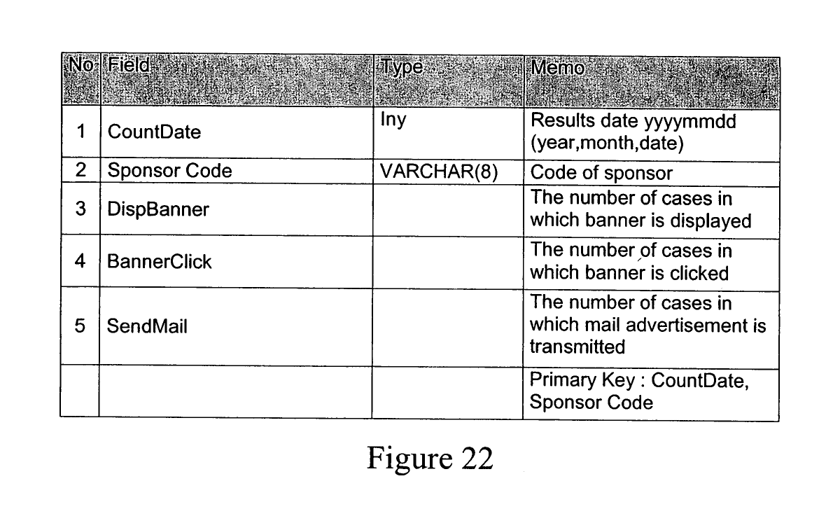

FIG. 22 contains the table definition for the “Sponsor Count” table. This table stores information for the advertising sponsors that are registered in “Sponsor Information Registration” table to check and confirm the number of times a banner has been displayed or a sponsor's text message has been sent to an IR. A sponsor can use his “Sponsor Code” and “Password” that are registered in “Sponsor Information Registration” table to check these statistics and confirm all Information on this table. The number of “DispBanner” (number of times a banner has been displayed), “BannerClick” (number of times a banner has been clicked to take an IR to the sponsor's website) and “SendMail” (number of sponsor messages sent via email) are displayed and counted automatically when these activities occur.

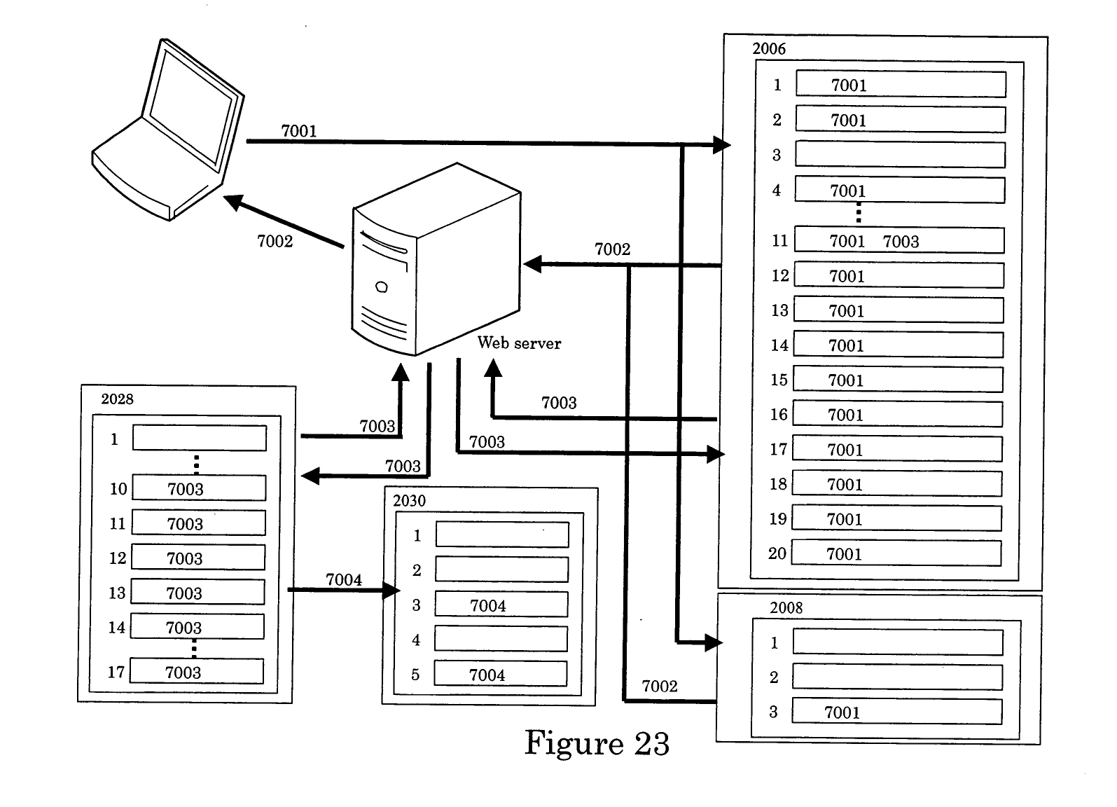

FIG. 23 is a schematic diagram explaining some of the interaction between an IR and the PR system. The IR is represented by IR-N in the figure., IR-N interacts with the “Sponsor Information Registration” table 2028, the “Sponsor Count” table 2030, the “PRaddress Information Registration” table 2006 and the “PRaddress Subject Registration” table 2008. At 7001 an IR initiates a search and inputs search conditions to define desired content. He does so by entering terms in the interactive search block of the PR system website. IR-Ns search is transmitted to the PR system. The PR system then carries out the search. Results are displayed at 7002 to IR-N when there is a corresponding data in the fields of at least one record of the “PRaddress Information Registration” table 2006. A predetermined maximum number of hits, for example, 10 hits are displayed on a single response screen at once. Additional hits can be displayed by clicking on an interactive button also displayed on a search results page. Of course other display arrangements can be used. Appropriate screen displays alert the IR when there are multiple screens of “hits” to display.

Sponsors (including email sponsors and banner display sponsors) are an important source of revenue to the PR system. Sponsor banners or messages are displayed with search results on web pages and as a part of email messages that respond to IRs who sent email queries to the PR system. Sponsors can agree to various programs of sponsorship which set criteria for display of sponsor banners or sponsor messages. Sponsors can be selected for display based on affinity to the subject matter of a search or affinity to a particular search result. For example an IR who sends an email message to the PR system seeking a discount coupon for a hamburger, might receive as part of his email response, a banner text message from the ABC Hamburger Shop which might contain a free drink coupon. Similarly, an IR who conducts a similar search via the PR system website, might see a banner display of ABC Hamburger Shop on the page on which search “hits” are displayed. Various arrangements can be made for associating particular sponsors with various categories of search and display information.

When a new IP joins the PR system as an IP member, the IP registers information that is stored in the various fields of the “PRaddress Member Registration” table 1054, such as a “TypeBusiness” (field 18, FIG. 11). For example, an IP named “ZZZ Drink Company” indicates during registration that its type of business is “soft drink”. This information is stored in the “TypeBusiness” field of the “PRaddress Member Registration” table 1054. If ABC Hamburger Shop becomes a banner sponsor, it registers Information in the “TypeBusiness1” (field 10), “TypeBusiness2” (field 11), and “TypeBusiness3” (field 12) fields of the “Sponsor Information Registration” table 2028 (FIG. 21).

For example, the ABC Hamburger may store the following data:

“TypeBusiness1” = “soft drink”
“TypeBusiness2” = “hamburger shop”
“TypeBusiness3” = “restaurant”

in the “Sponsor Information Registration” table 2028.

When an IR access queries the PR system to search for JOB Information of ZZZ drink company using his cellular phone to send an email message, the search result will be delivered as part of an auto reply email. That email may have a banner message portion including a sponsor banner of ABC Hamburger Shop because the search carried out for the IR “hit” on “soft drink” in the “TypeBusiness” field of the “PRaddress Member Registration” 1054 table because it is the same as or similar to data associated with ZZZ drink company which also lists “soft drink” as a relevant type of business.

At 7003, there is provided a process by which particular sponsors are selected for display in search results. For example, if a display accommodates only two sponsor banners and there are three potential sponsors for a particular search result, two will be selected for display. The choice can be made in a random selection process or according to predetermined rules for selection.

Businesses who want to become sponsors join the PR system and register information that becomes stored in a “Sponsor Information Registration” table 2028 (FIG. 21). When various fields of data, such as “TypeBusiness” in “PRaddress Member Registration” table 1054 registered by an IP corresponds with data in a corresponding field of the “Sponsor Information Registration” table 2028, such as “TypeBusiness1” “TypeBusiness2” “TypeBusiness3”, two sponsor banners out of the search results are displayed.

The displayed sponsor banner has an html link stored in field #13 causes a sponsor's image (such as a trademark stored at that link to be displayed. An html link to the sponsor's web page is stored in field #14. If clicked, the IR is taken directly to the sponsor's linked web page. The html links are generally of the following form:

“http://www.PRaddress.com/click.php?sc = Sponsor Code” < a
href = and “SponsorBanner” “_{—} blank” >< img src = target = ..
..alt =“”Border .... =“ 0” ></ a>.

The sub-tag “http://www.PRaddress.com/click.php” is a link to a click total routine that counts the number of clicks by IRs.

The registration of the advertising results for the access numbers and the delivery information of the sponsor's “banner material” is signified by reference numeral 7004. An IR inputs a search condition according to the content desired by the IR. The PR system receives the search. When data stored in a record of the “TypeBusiness” field of the “PRaddress Member Registration” table 1054 corresponds to data stored in any one of “TypeBusiness1” “TypeBusiness2” “TypeBusiness3” in “Sponsor Information Registration” table 2028, the number of delivered sponsor banners and the search result of the transmission are registered in the “Sponsor Count” table 2030 and “Sponsor Information Registration” table 2028.

To register data in “Sponsor Count” table 2030, the system searches to determine if there the same data exists as a “Sponsor Code” in “Sponsor Information Registration” table 2028 and in the “Sponsor Count” table 2030 on the date of registration. When the “CountDate” field of the “Sponsor Count” table 2030 is the same as the system date (yyyymmdd) of the server, the “DispBanner” field of the “Sponsor Count” table 2030 is incremented. If a “Sponsor Count” table 2030 does not exist when needed, it is created. This is done for a security reason. For example, a sponsor banner might be delivered right after the banner sponsor is registered in “Sponsor Information Registration” Table. In this case, there might not be sufficient time to generate the “Sponsor Count” table that is supposed to be generated automatically. If it is happened, it will generate “Sponsor Code” of the banner sponsor which is linked with “Sponsor Count” table and register the count data as backup.

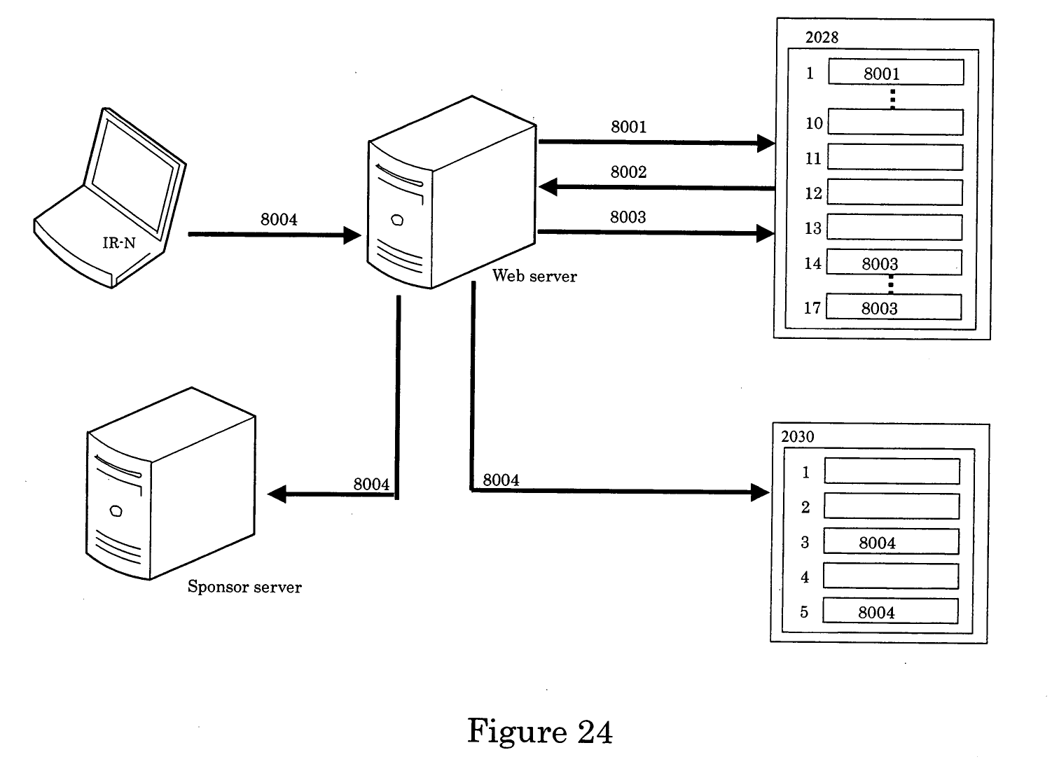

FIG. 24 is a schematic diagram showing interaction between an IR and the “Sponsor Information Registration” table 2028 and “Sponsor Count” table 2030. It describes a process that occurs when a sponsor banner is clicked by an IR. An IR initiates a search by providing search terms to the PR system (for example, by accessing the search engine through a website template). The search terms are used to query database 368. In the event of search hits, when information stored in the “TypeBusiness” field of a record of the “PRaddress Member Registration” table 1054 corresponds with data stored in any of “TypeBusiness1”, “TypeBusiness2”, and “TypeBusiness3” fields of the “Sponsor Information Registration” table 2028, the number of the delivered “Banner material” and the search result of the transmission are registered in the “Sponsor Count” table 2030 and “Sponsor Information Registration” table 2028 automatically and the url linked with a banner that is registered in the field “SponsorURL” of “Sponsor Information Registration” table 2028 is displayed.

At 8002, to display “URL that is linked with the banner”, search “Sponsor Code” in the data that is registered in “Sponsor Information Registration” table 2028 is equal to $HTTP_GET_VARS [“Sc”] or not (FIG. 24, 8001). When the corresponding data doesn't exist, an error message is displayed.

When corresponding data does exist, “SponsorURL” that is registered in “Sponsor Information Registration” table 2028 is displayed at 8003. The number that is accessed with “URL that is linked with the banner” in “Sponsor Count” table 2030 is registered automatically at 8004. To register in “Sponsor Count” table 2030, search if there is the same data of “Sponsor Code” in “Sponsor Information Registration” table 2028 with “Sponsor Count” table 2030 existed or not at the date to register. And when the “CountDate” field of the “Sponsor Count” table 2030 is the same as the system date (yyyymmdd) of the server and “Sponsor Code” in the data that is registered in “Sponsor Information Registration” table 2028 is equal to $HTTP_GET_VARS [“Sc”], add one (1) to the number of stored in the field “BannerClick” of the “Sponsor Count” table 2030 and update. Register to add “Sponsor Count” table 2030 when if “Sponsor Count” table 2030 does not exist.

The following describes the process that occurs when an IR inputs a search condition and sends to the email address of PRaddress. When the information recipient sends a “search” email such as

job@10234.nyc.PRaddress.com the address of the mail received at PRaddress.com is mapped to the email address search@PRaddress.com by the mail server of PRaddress.

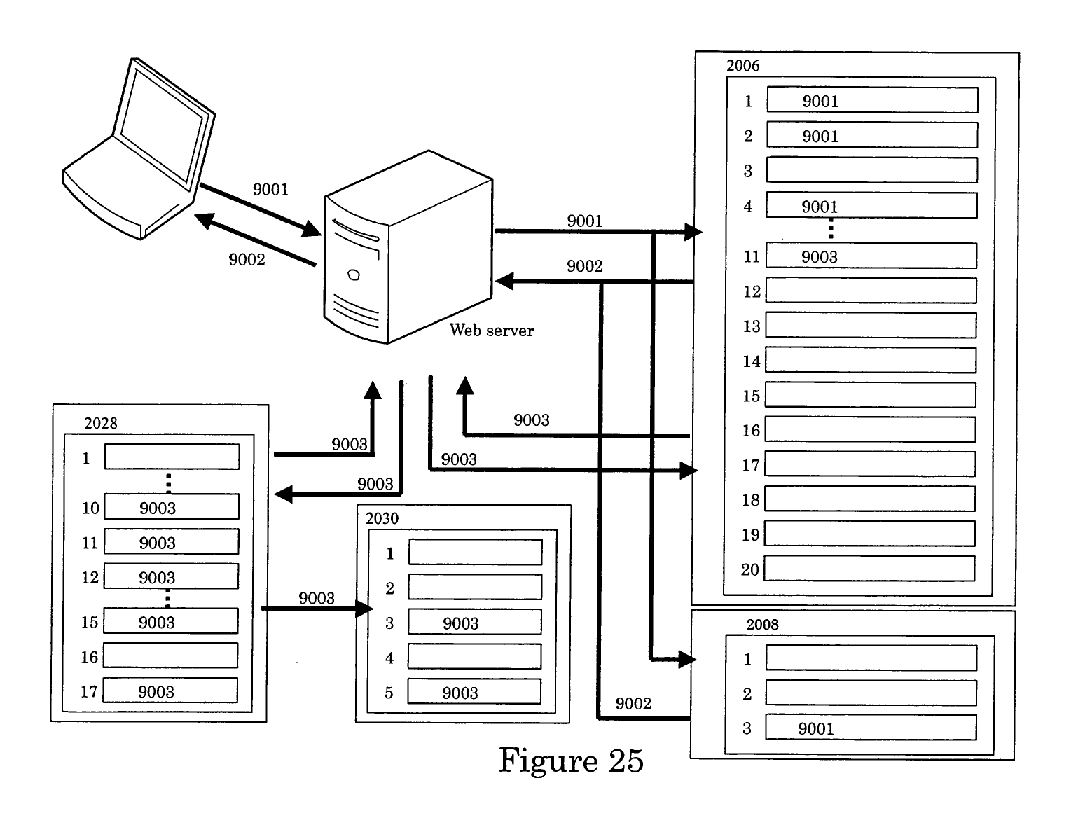

FIG. 25 is a schematic diagram showing interaction between an IR and the “Sponsor Information Registration” table 2028, “Sponsor Count” table 2030, PRaddress Information Registration” table and “PRaddress Subject Registration” table. It explains how the email search is analyzed. At 9001 the email job@10234.nyc.PRaddress.com sent by the IR is received. This email can be blank because the various search criteria are built into the [To:] email address. This email address is manipulated at the mail server to extract the various portions of the address that constitute search terms. The search email above, when written in a generic fashion has the general form:

subject@[PrCode or “PrName”].[state].PRaddress.com

The various component parts of the email address signify search criteria: “job=subject” “10234=“PrCode” or Pr Name” “nyc=state”. The “state” is not limited to representing only states per se, but rather is used as a more general geographical term that could include other jurisdictional boundaries such as New York City (nyc). In this manner, the email address is parsed to provide various search terms that can be used to query the database of IP information.

A search is carried out using various search techniques including but not limited to an SQL search of the database, using a search engine, etc. The search terms are compared with the various fields of data registered in the “PRaddress Information Registration” table 2006. If there is data in the table corresponding to the search terms, a “hit” is generated. For example the search criteria can be used to look for corresponding data in the fields for “Subject” “PrCode” “PrName” “state” in the “PRaddress Information Registration” table 2006. Fields of data in the tables are based on the corresponding search criteria parsed from the email address.

“Subject” searches the “Subject” field of records of the “PRaddress Subjects Registration” table 2008 related with “PrCode” “EntryNo” of “PRaddress Information Registration” table 2006. The “State” field will be the searched if it is provided by the IR in formulating his search.

For example, an SQL search could be carried out using SQL commands in MySQL such as the following:

SELECT PRaddress. * FROM praddress inner join PraddressSubject
on Praddress.PrCode=PraddressSubject.PrCode
and Praddress.EntryNo=PraddressSuject.EntryCode
and ‘job’=PradrssSubject.Subject
WHERE (Praddress.PrCode)=‘10234’or Praddress.PrName=‘10234’
and Praddress.Address like ‘%nyc%

The result obtained from running the search is transmitted back to the IR who sent the email search by using an auto reply function of the email server, as represented by reference numeral 9002. When there is a single “hit” as a result of the search, the data that is registered in “PRaddress Information Registration” table 2006 is sent back to the IR by automatic email reply. When there are two (2) or more hits resulting from the search, the email reply to the IR indicates that fact and there may be automatic follow up emails to deliver all of the information found during the search. When the search results in no hits at all, an appropriate message is sent to the IR so indicating.

When the search finds a “hit”, for example in the “TypeBusiness” field in the “PRaddress Member Registration” table 1054 and any one of the fields “TypeBusiness1” “TypeBusiness2” “TypeBusiness3” in the “Sponsor Information Registration” table 2028, a text message, as stored in the “MailMsg” field (FIG. 21), field #15) of the “Sponsor Information Registration” table 2028 is inserted in the auto-reply email sent to the IR. When there are three or more hits as a result of the search, two (2) “Text message” may be selected at random or according to some predetermined criteria and are sent back to the IR by email. When the corresponding data are existed, “MailMsg” that is registered in “Sponsor Information Registration” table 2028 is displayed and the number of “Text message” that is transmitted is registered in “Sponsor Count” table 2030 automatically. To register in “Sponsor Count” table 2030, search if there is the same data of “Sponsor Code” in “Sponsor Information Registration” table 2028 with “Sponsor Count” table 2030 existed or not at the date to register. When the “CountDate” of the “Sponsor Count” table 2030 is the same as the system date (yyyymmdd) of the server, the number stored in the “SendMail” field of the “Sponsor Count” table 2030 is incremented. If the “Sponsor Count” table 2030 does not exist when needed, it is created (9003). This is done for a security reason. For example, the sponsor banner might be delivered right after the banner sponsor is registered in “Sponsor Information Registration” Table. In this case, there might be insufficient time to generate the “Sponsor Count” Table that is supposed to be generated automatically. If it is happened, it will generate “Sponsor Code” of the banner sponsor which is linked with “Sponsor Count” table and register the count data as backup.

FIG. 26 is a schematic diagram of an exemplary homepage for the PR system located at PRaddress.com as seen by a PC-based user. The web pages of PRaddress.com allow users with Internet service to have an easy gateway into the PR system. As already mentioned, this is not the only way users can access the PR system. The home page takes a user to other pages in the web of PRaddress.com through clickable links, software programming, etc. A clickable button 402 asks user is asked whether he/she would like to become an IP member. A clickable button 404 provides an IP member an opportunity to sign in. After sign in, an IP member can edit and update various “subjects” (FIG. 8) at anytime.

The home page includes a search template and appropriate links to a search engine associated with PR server 100. An interactive box 406 allows the user to enter search terms. The user then clicks on a clickable button 408 to initiate the search. The search engine enables an IR to search for information using a “PrCode” number, a “PrCode” name, an article, a keyword, etc. The home page also includes links that can provide the user with additional information. As an example, the home page might include links to sub-pages of the PRaddress.com web, containing information such as: “What is a PR address?”, “Information Recipient”, “Information Provider”, “Banner Sponsor”, “Partner”, “System”, “Frequently Asked Questions” (FAQ), and “IP member Log In”.

Interactive box 406 allows a user to input search terms such as “keyword”, “PrCode” number, “PrCode” name for a PR search. A PR search is quite different from the searches performed by typical search engines such as encountered on “Yahoo”, “Google”, “MSN”, “Excite”, etc. A PR search is a much more “targeted” search that is not searching the entire universe of web pages. It is, in essence, a query of a database holding limited information from a limited number of IPs. An IR inputs key words that identify specific “subject” areas and “categories” for company information desired. For example, when IR doesn't know a code number or code name of IP, the IR might select a single “category” and perhaps a single “subject” of interest, a location (city and state or zip code) and input them as keywords into interactive box 406. For example, If the IR is looking for a part time job at a Hamburger Shop in New York City, the IR will input <Restaurant Hamburger Job NYC>.

IRs can access information based on various organizational features such as Listing of Directories 470, Listing of Categories 409 and Listing of Subjects 413. Text blocks such as “Search by DIRECTORY” text block 472. “Search by CATEGORY” text block 411, and “Search by SUBJECT” text block 412 guide the IR to the listings displayed in Listing of Directories 470, Listing of Categories 409 and Listing of Subjects 413, respectively. PR CATEGORY button 410 allows an IR to initiate a search based on a selected PR CATEGORY. PR SUBJECT button 414 allows an IR to initiate a search based on a selected PR SUBJECT.

A “beginner” IR user might begin a search by clicking on PR CATEGORY button 410. This enables the “beginner” IR to search PR IP members by consulting a directory of IP members using a hierarchical menu structure based on “category” (FIG. 7). A category search is easy to carry out. It does not need a very elaborate menu structure. For example if an IR clicks on the category “Money” he immediately sees a list of all IPs who have self-associated with that category. Each IP is listed by name, along with associated “PrCode”, “PrName” and location. An IR can select one of the IPs from a list displayed.

The menu might include top level menu listings such as: “Business & Economy”, “Computers & Internet”, “News & Media”, “Entertainment”, “Recreation & Sports”, “Health”, “Government”, “Countries, Regions, US States”, “Society & Culture”, “Education”, “Arts & Humanities”, “Science” and “Social Science”. For example, when an IR clicks on a menu listing for “Business & Economy”, further menu choices will narrow the IR's focus to companies that have self-selected to be categorized under “Business & Economy”. If an IR chooses “Food & Restaurant” from a top level menu, then the next screens would direct the IR to the various IP members who have associated themselves with that category. If the IR then narrows his choice to “Fast Food” the IR can then view a list of the associated IP members along with their respective “PrCode”, “PrName”, company name and location.

Then, the IR selects one of the sixteen (16) “subjects” (FIG. 8) about which he would like to retrieve information.

The PR SUBJECT button 414 provides an opportunity for an IR to search by “subjects” (FIG. 8). The “subject” search provides a different window through which the IR can enter the PR system and retrieve data. For example, suppose an IR initiates his search by selecting <Job offer>. The next screen might show a list of the eighteen (18) “categories” (FIG. 7) to allow the IR to narrow his search.

A “Search by PR code number/name” interactive box 416 a PRCode button 418 provides an IR with an opportunity to search by “PrCode”. This window into the PR system is provided for an IR who already knows a “PrCode” or “PrName” and wants fast access without wading through a menu structure. The “PrCodes” are organized into groups for easy location, such as “1-9999, 10000-99999, 100000-999999, 10000000-9999999.” If an IR knows a “PrCode” number, such as <10234> of ABC Hamburger, he can receive job information in response to inputting “10234 JOB” as a key word in a search engine to view a PR message board within a JOB subject on a screen and/or to receive a PR message within a JOB subject by sending an email at JOB@10234.PRaddress.com.

Sponsor banners 420 can be displayed on each PR homepage. As an example, three such sponsor banners are illustrated. As examples, banner sponsors are available for:
PR address website for PC
PR address website for cellular phone
PR subject website
PR subject website for cellular phone
PR subject box of all information suppliers, and
PR subject box of all return mail from information suppliers.

Blocks 422, 426 and 424 are intended for users with Internet access to PRaddress.com. Block 428, block 430 and block 432 are intended for users without Internet access to PRaddress.com. Users without Internet connection can access the PR system though access points provided by a private network affiliated with the PR system. This network can include network affiliates who provide access points through various direct connections such as dial-up service.

Blocks 422 and 428 are intended for PC users. Blocks 426 and 432 are intended for cellular/PDA users. Blocks 424 and 430 are intended for cellular users that have text message capability including SMS devices.

At 422, there is a clickable button is labeled “PC/Notebook User with Internet Connection—Click HERE to send a PRaddress Search Engine template to your email.”

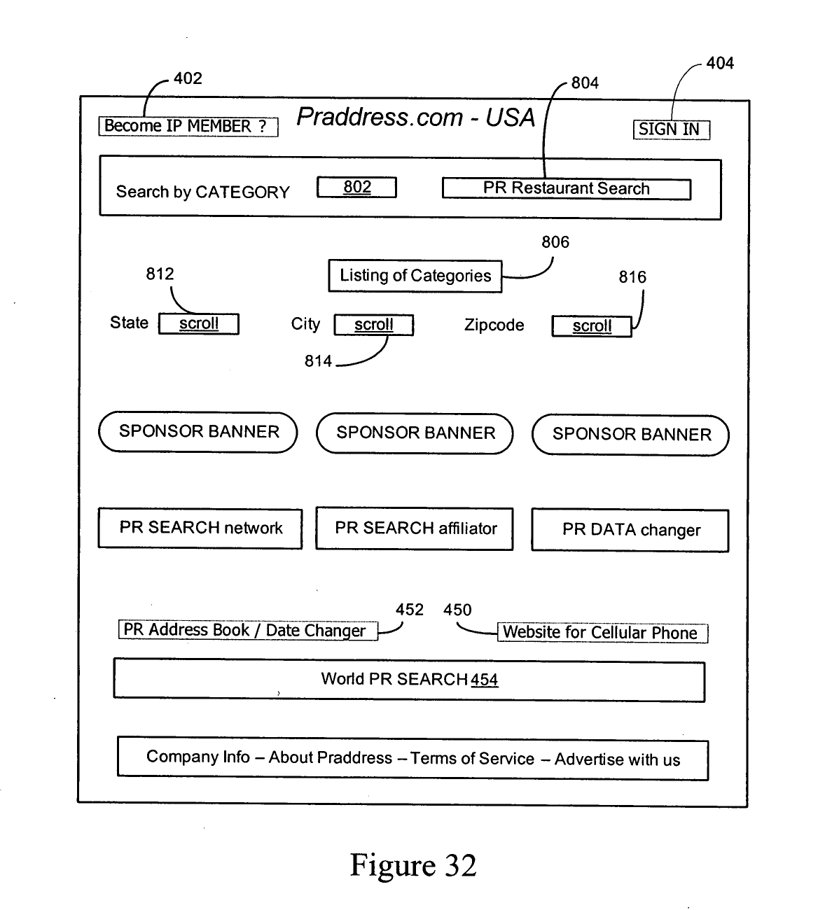

At 426, there is a clickable button is labeled “Cellular Phone User with Internet Connection—Click HERE to send a PRaddress Search Engine template to your email.” This button allows any user (cellular, PDA and other terminal users) with an Internet connection to send send an email or download a template of PRaddress search engine. A cellular user with internet connection is taken to a web page designed for cellular users using the form factor of a typical cell phone, PHS or PDA screen, such as, for example a Wireless Application Protocol (WAP) enabled web page. An example is shown in FIG. 32.

At 424, there is a clickable button is labeled “Cellular Phone User with text message and Internet Connection—Click HERE to send a Category/Subject/Code list to your email.” Here the intended user is one without an Internet connection such as, for example, a cellular phone user, PDA user or AOL user, etc. Using this button, a cellular phone user without Internet connection to send a PRAddress Yellow Page type listing of IPs with code number, code name, company name, Category and location by email with text files. The lists that will be sent might be limited depending upon what kind of message service IR made a contract with cellular phone carriers, message service carriers or SMS.

At 428, there is a clickable button is labeled “PC/Notebook User with Direct Connection—Click HERE to send a PRaddress Search Engine template to your email.” This button allows a PC/Notebook user with a dial-up direct connection to download a template for inputting a search request to the search engine. After this template has been downloaded, a PC/Notebook user can upload a search request to the server and find information made available by IPs without accessing a web page of PRaddress.com. Once an IR user downloads the PR search engine template into his device of choice he can use PR system immediately.

A dial-up connection is available to PR server 100 through a network associated with the PR server. Thus, PR server 100 can be accessed without the Internet and without the need to follow Internet communication protocols. The dial-up connection can be used in connection with a service program in which the PR system becomes a selectable item (charge or at free of charge) of a service menu operated by a carrier or other type of network. Thus, there is provided easy access for all to the PR system without the need to set up hundreds of access point for dial-up direct connection by utilizing above existing facilities.

At 432, there is a clickable button is labeled “Cellular Phone User with Direct Connection—Click HERE to send a PRaddress Search Engine template to your email.” This button allows a Cellular Phone/PDA/Palms/Blackberry/PHS/AOL and other Data Communication Terminal users with a dial-up direct connection to send by email or download a template for using the PR system's search engine. As used here, “cellular user” includes Palm, Blackberry, PHS, AOL with Internet connection, etc. A cellular user with internet connection is taken to a web page designed for cellular users using the form factor of a typical cell phone or PDA screen, such as, for example a Wireless Application Protocol (WAP) enabled web page.

At 430, there is a clickable button is labeled “Cellular Phone User with text message and Direct Connection—Click HERE to send a Category/Subject/Code list to your email.” This button allows a cellular phone user with a dial-up direct connection to the PR system server. This service may be limited to text messages given the format of the cellular service. Thus an IR may be limited to receiving a “Yellow Page” type listing of IPs with “PrCode”, “PrName”, company name, category and location. The lists that will be sent might be limited depending upon what kind of message service is available to the IR given the limitations of various cellular and SMS services.

The PR system provides service through a dial-up direct connection (blocks 428, 432, 430). For IPs and IRs who connect in this manner, the PR system does not have to follow any particular Internet protocol requirements. A dial-up connection can be utilized by having a service program accessed via a menu selection such as offered by a cellular carrier. Such connection could be free of charge or on a fee for service basis depending on the business model selected. Such service can be made available to subscribers of various carriers, ISPs, various networks and search engine companies. By utilizing the infrastructure of such “partners” it is not necessary for the PR system to set up hundreds of access points for dial-up direct connection.

By clicking on a PR SYSTEM network button 440 a user can see a listing of “network partners” that together constitute the PR system network. Some of these partners may be companies who have their own networks and have made some agreement with the PR system to provide access to the PR servers. Examples of such network partners include: cellular carriers, PDA networks/Palm networks/Blackberry carriers/PHS and other data wireless communication carriers, fiber cable/cable/satellite carries, ISPs including ADSL, DSL, Dial-up, AOL® and search engine Companies will be suitable network partner for PRaddress.com. Many such companies already have a large established user base. Making a license agreement with such companies provides ready access to such customer base to the PR system. The PR system can utilize partner's access points, such as for example, dial-up connections.

By clicking on a PR CATEGORY distributor button 442 a user can display a list of “Category Distributors”. Category distributors are businesses that have an agreement with the PR system to administer one or more of the “categories” into which IPs are organized. They are responsible for promoting the PR system to businesses that relate to their assigned “category” (FIG. 7). A category distributor might enter into an exclusive agreement with the PR system to promote use of the PR system among business that relate to a particular category such as, for example, “Music”. The total of distributors is not fixed and can change from time to time. The following examples explain aspects of the business model of the PR system.

### EXAMPLE 1

T-Mobile Cellular Company has 12 million subscribers in the US. T-Mobile wants to use our PR solution within their T-Mobile subscriber base. T-Mobile is able to start a new service and generate a new income stream by licensing our PR solution.

### EXAMPLE 2

BIGISP is an ISP with 15 million dial-up and broadband users and wants to use our PR solution. BIGISP can inaugurate a new service and create a new revenue stream by licensing our PR solution.

### EXAMPLE 3

PDAs For All, Inc. sells PDA devices and has a large customer base and operates a packet data network for providing messaging and Internet information access. PDAs For All, Inc. can enter into an OEM/Licensing agreement with the PR system to offer access to PRaddress.com.

A PR SYSTEM menu button 444 links the user to a list of “partners” who have made the PR system a selectable service menu item on their own systems. This list might include, for example, a cellular company that has a service menu system and has made the PR system a menu choice on that service menu system. The list of such “partners” could include cellular carriers, PDA/Palms/Blackberry/PHS and other data wireless communication carriers, fiber cable/cable/satellite carries, ISPs, and Search engine Companies. In order for the PR system to take advantage of dial-up direct connection infrastructure already in place (428, 432, 430), the PR system makes agreements to become “service menu items” on other's systems, such as becoming a menu choice on a service menu of a cellular carrier.

A clickable button 446 allows a user to view a list of PR “subjects” Distributors. PR Subject distributors are businesses that have an agreement with the PR system to administer one or more of the “subjects” into which IPs upload information for distribution. The subject distributors are responsible for promoting the PR system to businesses that relate to particular “subjects” (FIG. 8). A subject distributor might enter into an exclusive agreement with the PR system to promote use of the PR system among business that might want to promote information of a type that is one of the “subjects” of the PR system—such as, for example, “Jobs”. A subject distributor for jobs might be an employment agency who specializes in advertising and promoting job opportunities. The number of “categories” and “subjects” is flexible and is expected to change with demand.

A “Website for Cellular Phone” button 450 links the user to a special web page set up for cellular phone users.

A PR Address Book/Data Charger button 452 is provided on the home page. The PR address book is compilation of all of the IPs along with their respective code numbers and code names that are stored in database 368 along with other pertinent company information such as, for example, name, street address, city, state, zip code, type of business, category, etc. This information can also be published in hard copy as a “PR address book” in a fashion similar to that of a “yellow pages” phone directory. IPs can be listed in one section by code number and in another section by code name, for example. As IPs are added and data about IPs is updated electronically, the complete “book” of IPs or portions of the list of IPs can be published as a promotion of the PR system. When an IR has an opportunity to buy a hard copy of the PR address book, the IR can identify a particular IP whose information is sought and can utilize the PR system easily by searching all listing of code number and code name of IP members from the PR address book.

PR DATA charger is list of support companies that users can visit to upload certain operational data into their cellular phone/notebook/PDA/PALM/Blackberry/PHS/etc. This operational data may include search engine templates, and device format definitions that allow various types of devices to interface with the PR system. Some devices may locally store a list of “PrCodes”, “PrNames”, company names, locations, categories, and the like. This data can be periodically updated by such a support company. Other information that may be locally stored relates to message routing information such as Internet access information, dial-up information, etc.

### EXAMPLE

VZ Wireless agrees to provide PR data transport to all VZ Wireless stores in the New York metropolitan area. The PR system provides a terminal server at all VZ Wireless retail outlets. Anyone can stop in to such an outlet and access through the terminal server at data file which can be uploaded into their portable device free of charge.

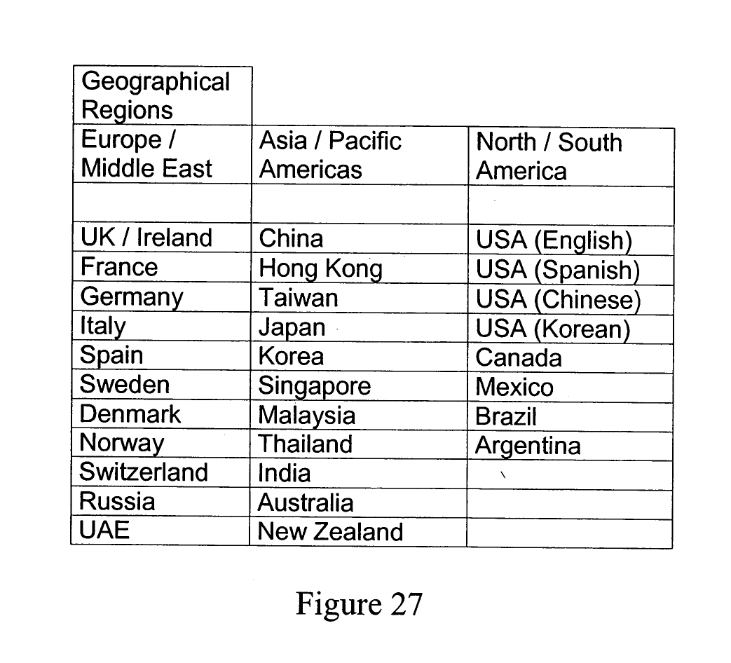

An area 454 is provided for conducting a World PR Search. In this area, the information providers are organized geographically. As an example, there are listed major areas and countries as shown in FIG. 27.

FIG. 28 is a schematic diagram of a form used to register with the PR system to become an IP member. This form is displayed to a user who clicks the “Become a Member?” button 402 (FIG. 26). A prospective member is presented with a form to be filled in with various pieces of information about the user that is later used to set up an account for the user to become an information provider. The prospective IP member provides data about his company/business and provides some keywords that can be put into the search engine for identifying his business to users who use the search engine in that manner. The new IP will be assigned a “PrCode” and “PrName” such as <ABCH> or <ABChamburger> as part of the registration process, and is asked to define a password.

A “scroll/click” button 502 allows the user to scroll and choose the type of business and category to be listed for a search engine. For example: Business & Economy→Food & Drink→Restaurant→Hamburger→<ABCH>. A message 504 suggests to the user new IP that he can choose one “category” with which to be affiliated. The list of categories appears in an area 505. The PR system may provide that a third party manage each CATEGORY under certain terms and conditions. However, PR system manages the Category search as a unified database server.

A text message 506 suggests to the new IP that he can select a number of “subjects” under which to provide information. The list of subjects is provided in an area 507. The user can edit and update PR Information from IP member page at anytime. The “subjects” organization may change from time to time based on data capacity, changing interests, commercial purposes, etc. An OPTION button 508 allows the IP to select certain optional services. For example, the IP can choose to have made available an extra large capacity data server for serving a large volume of information. Some IPs may have very large data needs and may want to purchase additional space beyond normal amounts for an additional fee.

A text message in area 510 guides the new IP to select six (6) keywords that will provide direct “hits” by IRs conducting a search with those terms. The keyword entered into template box 530, template box 532, template box 534, template box 536, template box 538, and template box 540 are stored into the appropriate fields of tables in database 368 (FIG. 14, fields 13-18) so that an IR can easily find the IPs information using such keywords in a search. At 512 and 514, the user can select and confirm a password so as to maintain secure future access to the PR server.

At 516 the user can suggest a “PrName”. This “PrName” may be related to the company name, an organization name, a product name, etc. Hopefully, it is a name that is simple and easily remembered. This “PrName” serves as one of the possible “entry” points into the system that an IR can use to access the IP's information. At 518 a “PrCode” number will be provided automatically and free of charge by the PR system. However, if the IP member wants to select a particular number, an OPTION is available at 520 to enable selection by the IP member for a fee. The IP member is encouraged to use his newly acquired “PrCode” name and “PrCode” number on it's business communications, such as business card, website, TV advertising, posters, brochures, etc. to acquaint people with these identifiers.

At 522 once the IP member is registered as a banner/advertising sponsor account, they can advertise anytime. There is a message 524 displayed near the bottom of the page. For example, the message might read:
“By submitting your registration information, you indicate that you agree to the Terms of Service and have read and understood the PR address Privacy Policy. Your submission of this form will constitute your consent to the collection and use of this information and the transfer of this information to the United States or other countries for processing and storage by PR address! and its affiliates.
You also agree to receive required administrative and legal notices such as this electronically.”

Once the user has completed the form, it is submitted with a click to the “submit this form” button 526.

FIG. 29 is a schematic diagram of a sign in web page. There is provided an interactive box 602 in which the member can enter his ID name and a box 604 in which the member can enter his password. A check box 606 makes a “cookie” available for remembering the ID so that the user does not have to retype it for each access. A “sign in” button 608 allows the user to submit the entered information. A “forgot your password” box 610 is provided for users who need help refreshing their memory of the password. By signing in with a “PrCode” and password, the member is taken to an interactive form shown in FIG. 30.

FIG. 30 is a schematic diagram of a web page that acts as a gateway for the IP member. It includes interactive areas allowing the member to get helpful information, such as: “How to use PRAdress.com” at area 620, “About Contents of Subject Box” at area 622, “Regulation of Contents” at area 624, Paid Contents of Subject Box” at area 626, “About paid advertising” at area 628, and “Frequently Asked Questions” (FAQ) at area 630. This page also permits the member to enter information to be provided to users, such as “Info.”, “PR” “Job Offer”, “Press”. The member can edit at 632 information entered into the system such as “New”, “Sale”, “Special”, “Coupon”, “Discount” and so on. The member can receive statistics at 634 from the system indicate usage by users who identify the member by requesting information. These statistics can include “Log Analyzer”, “Subject”, “Date”, etc. This page can also include information about capacity. For example it might display a message: “Capacity of Free Subject is up to 10 MB with text message only. Pictures and Html files with extra capacity will be optional.” As another example, the following message might be displayed: “Capacity of Paid Subject is up to 100 MB with text message only. Some users may want to provide space intensive information such as photos and html files, so capacity statistics and the ability to purchase extra capacity will be provided.

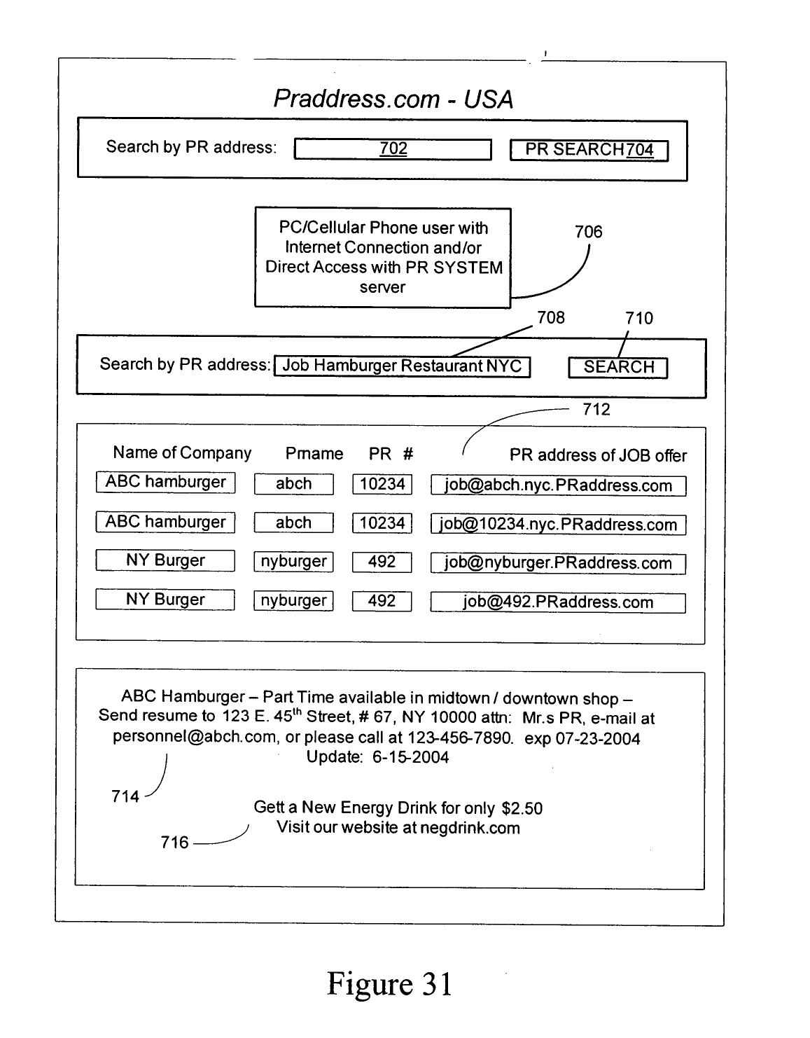

FIG. 31 is a schematic drawing of a web page to which a user is taken from the “Search by PR address” portion of the home page (FIG. 26). An interactive box 702 is provided for the user to enter search words (for example, key words). A clickable button 704 then executes the search. The PR search engine can be searched by “PrCode” name such as <ABCH>, Company name such as <ABC Hamburger>, or “PrCode” number, such as <10234> to get a direct access. The PR search engine could be searched by directory and subject to get matching lists.

A PC/Cellular phone user with an Internet connection can activate button 706 and, for example, search by PR address: “Job Hamburger Restaurant NYC” for example, if the user wanted to determine if there were any job offers posted by hamburger restaurants in New York.

The results are returned in area 712 in response to the search. Clicking on the second of the four results would provide the following message in area 714:

“ABC Hamburger - Part Time available in midtown/downtown shop -
send resume to 123 E. 45^{th} Street # 67, NY 10000 Attn: Mrs. Smith at
personnel@abch.com, or please call at 123-456-7890. Exp Jul. 23,
2004, updated Jun. 15, 2004”

As an extra “bonus” the user might receive an advertising message or even a discount coupon in area 716 from an advertising sponsor such as: “Get a New Energy Drink for $2.50—visit our website at negdrink.com”.

FIG. 32 is a schematic diagram of an exemplary web search page illustrating a search that was begun by accessing “PR Category”. The PR system provides a separate and distinct web page for each representative business category. In this example, the user types in “nyc restaurant hamburger” in interactive block 802. The subject heading “PR Restaurant SEARCH” is selected in block 804.

(Example: http://www.PR-Restaurant.com

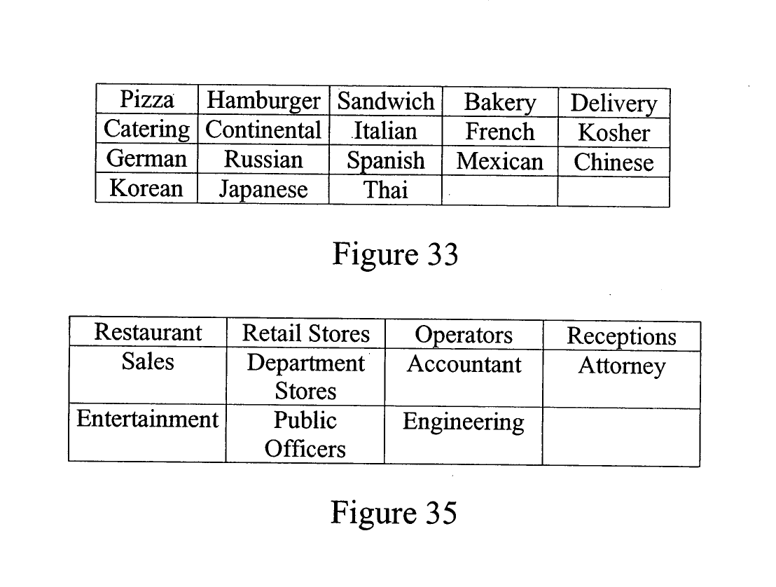

This web page is devoted to restaurants. Thus, in this example, ABC Hamburger would be included in the database whose information is displayed on this page. In area 806 there are displayed sub-categories of restaurants, as shown in FIG. 33. Scroll box 812, scroll box 814, and scroll box 816 provide the user the ability to zero in on a geographical location of interest.

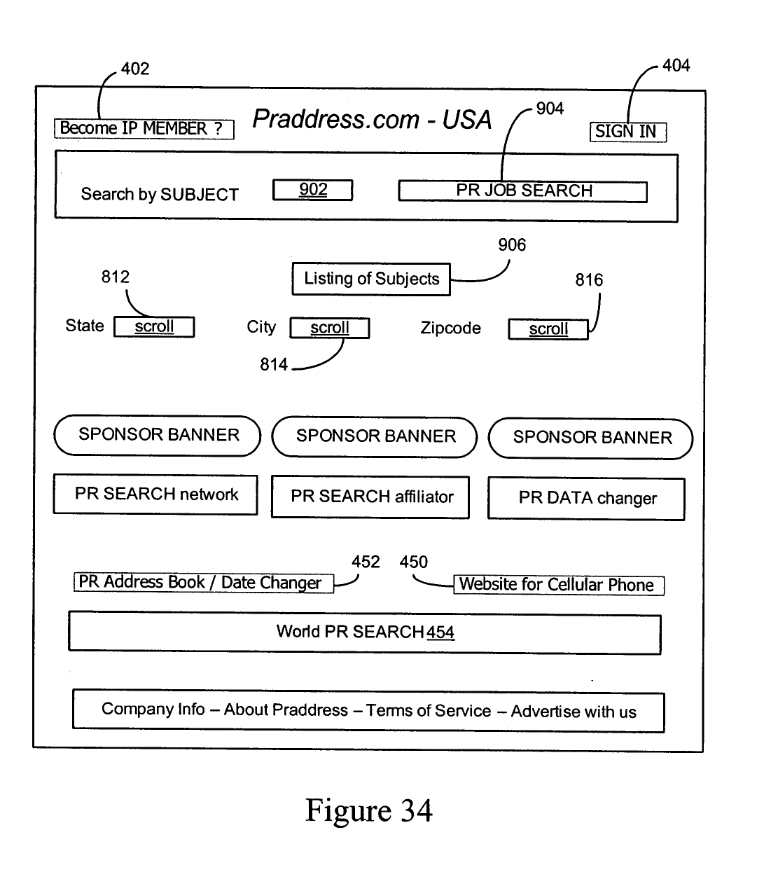

FIG. 34 is a schematic diagram of an exemplary web search page illustrating a search that was begun by accessing PR SUBJECT. In this example, the user is trying to locate a job. The web page shown in FIG. 29 could be retrieved as a result of a user's direct access from the home page through a search or category/subject selection. For example, http://www.PR-iob.com. PR system will be more practical and convenient PR information service for both IR and IP by managing an Independent Subject Server. In the example shown in FIG. 31, the user typed “nyc restaurant hamburger” in a search term block 902 and performed a PR JOB SEARCH at block 904. A listing of more narrowly defined “subjects” appears in an area 906, such as, for example as shown in FIG. 35.

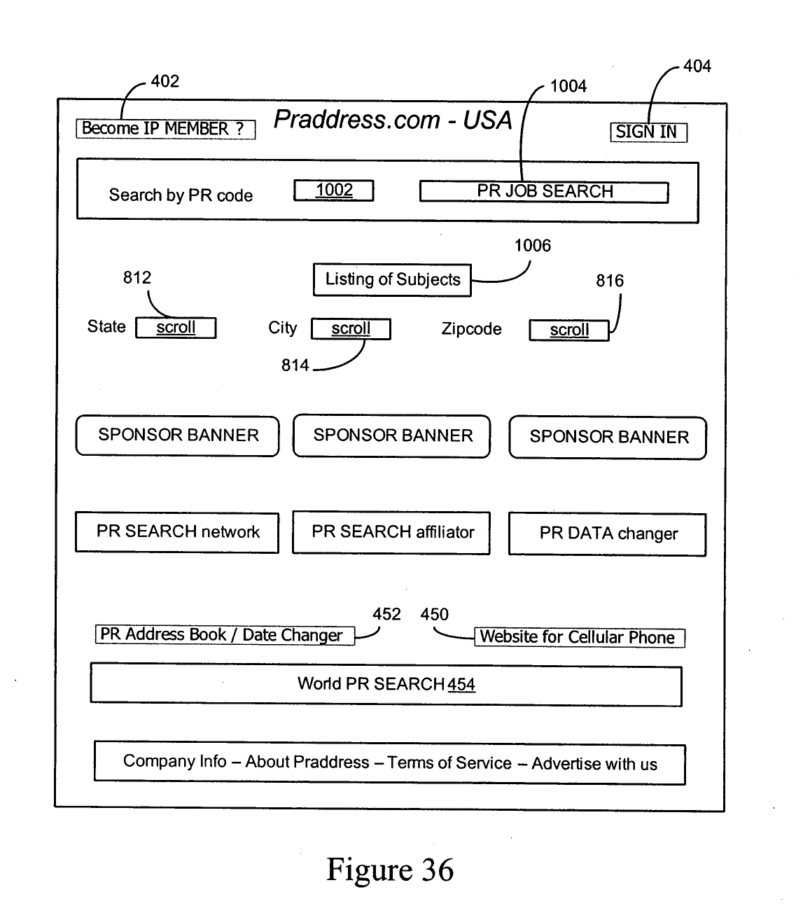

FIG. 36 is a schematic diagram of an exemplary web search page illustrating a search that was begun by accessing PR-code. Each IP has a “PrCode” number in the range of 1-99999999. If an IR knows the specific “PrCode” of an IP from which the IR seeks information, such as the PrCode of ABC Hamburger—<10234> he can narrow his search quickly. For example, if the IR wants to obtain job offer information posted by ABC Hamburger for job openings in New York City, the IR can easily access the information by entering “10234 JOB NYC” as search terms in a search field 1002 and then click on a PR JOB SEARCH button 1004 to initiate the search. For convenience, a listing of subjects is provided in a block 1006. An IR could accomplish the same search using the “To” address of a blank email message sent to the PR system such as, for example, JOB@10234.PRaddress.com.

Sponsor Banners are available on various web pages constituting PRaddress.com. For example:
PR address Top page for PC/Cellular Phone with Direct Access
PR address Web page for PC/Cellular Phone with Internet Access
PR address Top page for PDA users and SMS users
PR Category Top page (18 categories)
PR Subject Top pages (16 “subjects”)
PR subject boxes updated by IPs

For example, if PR system has 10,000 IP members with 16 “subjects”, 160,000 Information Boxes are available for Information Recipients to get. Suppliers.

The PR system provides “home” web pages for various types of users: PC user, mobile phone user, users of data communication terminals having Internet access, users of text messages, etc. Thus, the system is substantially universal in its ability to provide service to all.

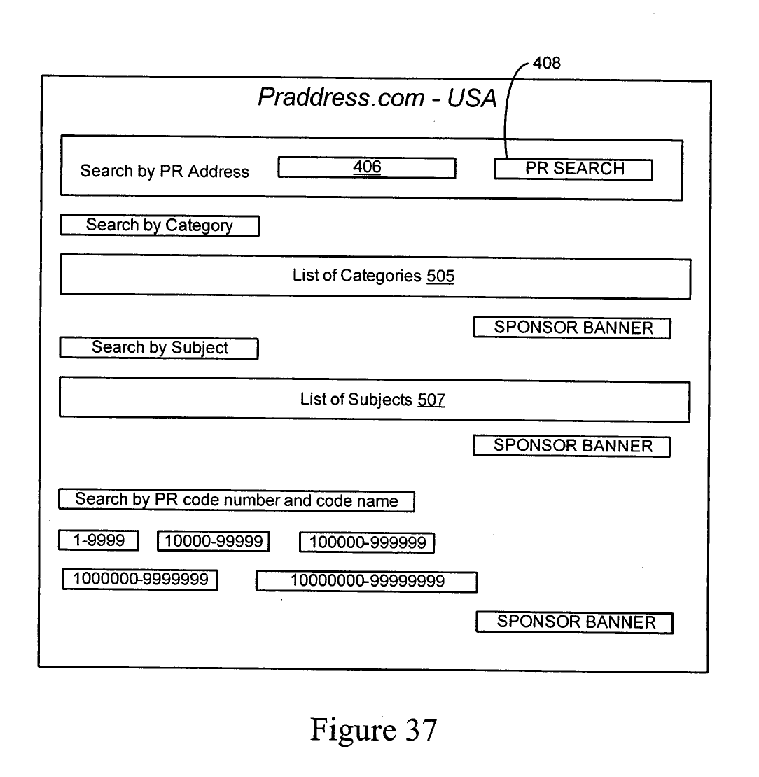

FIG. 37 is a schematic diagram of an exemplary web page that would appear to a user who has clicked on block 422 shown in FIG. 26. This particular page is intended for use by a PC/Notebook User with an Internet connection. An IR can download a template of PR search engine if IR wants to. It is also recommended that IR should download a latest PR address book. The PR search engine is not like other search engines such as Yahoo®, Google®, MSN®, Excite® and others that appear thousands of lists after input some keywords. IR needs to input keywords as least one of Categories, one of Subject, and State even if IR doesn't know a company name, a “PrCode” number or a “PrCode” name. With this, IR can get a PR Information by a return email or a viewing by a message box on a screen.

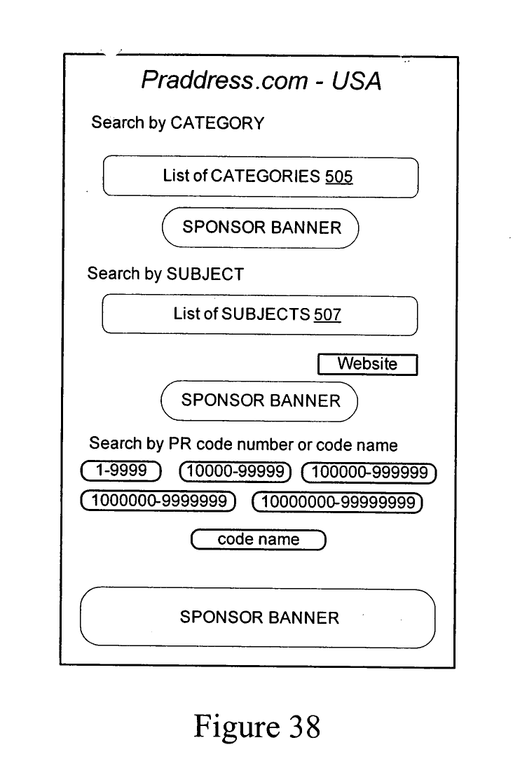

FIG. 38 is a schematic diagram of an exemplary web page used by a cellular phone based IR who does not have an Internet connection. This page is formatted for the small size and aspect ratio of a cell phone display. This page allows such a user to send a Category/Subject/Code list to the user's email address. A cellular based IR without an Internet connection can utilize the PR system via text messaging even without an Internet connection. One such text messaging service is the SMS provided by many cellular carriers. Others include various “instant messenger” services, etc.

Since the IR can not download formatted email or browse through Internet, the IR has to access with PR system by writing a concrete subject with a IP code name or a code number into an email address such as “job@ABCh.nyc.address.com” or “job@10234.nyc.address.com”. In response, the PR system will send Job Information of ABC Hamburger in NYC by an automated return mail with a text message to the IR.

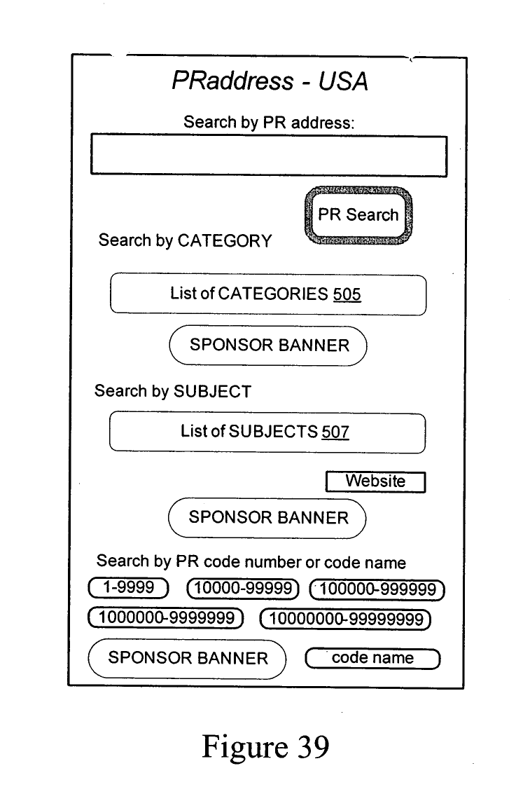

FIG. 39 is a schematic diagram of an exemplary web page used by a cellular phone based IR that may or may not have an Internet connection. The “web” page is formatted for the small size and aspect ratio of a cell phone display. The user can search by CATEGORY or SUBJECT by selecting from a list of categories 505 or a list of “subjects” 507. The IR can also search by selecting code numbers. The code numbers are organized into ranges of code numbers each assigned to a clickable button for easy selection by the user. The IR can obtain PR Information by receiving a return email or by viewing by a message box on the cellular display.

A cell phone based IR can take advantage of a direct connection to the PR server using the network associated with the PR system. In this way, the PR system can provide access to all search engines and web pages directly to a cell phone based IR. The cellular formatted “page” shown in FIG. 34 is also of the type seen by a cellular phone based IR who can dial a direct connection to PR server 100 by using the network associated with the PR system. Accessed in this manner, the PR system can make available to the IR all search engines and web pages. The IR can get PR Information by a return email or a viewing by a message box on a screen.

The PR search network includes companies/groups/organizations which enter into an agreement with owners of the PR system, such as, for example an OEM agreement or licensing agreement.

The following are examples that illustrate the concept of “network” described above.

### Network Example #1

XYZ-Mobile is a cellular carrier having more than 13 million subscribers in the US at the time of this writing. XYZ-Mobile wants to use the PR system described herein and make it available to its subscribers. XYZ-Mobile offers a new service by licensing the PR system and receives advertising income for its use.

### Network Example #2

BigISP, an ISP, has 20 million dial-up subscribers and ADSL Internet users in the US. BigISP wants to offer the use the described PR system as a new service to BigISP subscribers. BigISP is able to add PR system access as a new service and receive an additional revenue stream based on PR advertising by licensing the PR system.

### Network Example #3

PopPDA has 5 million users in the US. PopPDA wants to offer the use of the PR system within its PopPDA user group. PopPDA is converting our PR system as their original version as an additional PR advertising income source to PopPDA users under a licensing agreement with PRaddress.com.

The PR system described herein can be utilized by PDA customers on packet data systems and other communication networks, cellular customers, PHS customers, SMS device users, users of cable based communication systems, satellite based communication systems, ADSL and DSL customers, etc.

A PR category distributor is a company/group/organization which enters into a distributor agreement with PRaddress.com with regard to a particular category (FIG. 7). The following is a “category” example. Consider, for example the MUSIC category. The PR system has defined 18 categories with which IPs can identify. A company can be designated as the “distributor” or “promoter” for the category “music”. HappyTune, Inc. is a music promotion company that agrees to be such an exclusive distributor of the PR system for the music industry. HappyTune, Inc. provides a server dedicated to the music industry and associates with it a domain, such as, for example, http://PR-MUSIC.com. HappyTune, Inc. sets up its server to include 16 PR “subjects” related to the general category of “music”. HappyTune, Inc. servers link with PR system main server. HappyTune, Inc. promotes the PR system to sign up IPs affiliated with the music world and to advertise to IRs the existence of a PR server dedicated to music.

The PR system can promote itself in part by establishing a service program into other data communication carriers. For example, it could be accessed via a link from a menu of a data communication carrier service program or Internet homepage. For example, if No-wire, Inc. agrees to have a PR system be selectable as a service menu choice for No-wire, Inc customers under a certain agreed upon conditions. The PR system then becomes accessible to No-wire, Inc. customers acting as a gateway for the PR system.

Main targets will include ISPs, Carriers, Cellular Phone Carriers, PDA/PHS/Mobile Communication Carriers, Cable, Fiber Cable Carriers, satellite carriers, search engine companies, ADSL, DSL carriers, etc.

A PR “subject” distributor is a company/group/organization which enters into a distributor agreement with the PR system to maintain one of the sixteen (16) “subject” areas (FIG. 8). Each distributor can market and promote the PR system specializing in a designated “subject” such as “sale”.

### EXAMPLE

SPC, Inc., a sales promotion company agrees with PR system to be an exclusive distributor/promoter of the PR system for the “sale” subject matter. SPC, Inc. establishes an Internet domain such as http://www.PR-SALE.com and sets up a server with 18 “categories” (FIG. 7) of business that may be related to “sale”.

SPC, Inc. servers link with PR system main server. SPC, Inc. promotes the PR system and signs up IPs who want to advertise their respective sales information. In return, SPC, Inc. is paid a percentage of sales from PR advertising fees related to the “sale” subject.

As previously stated, a user can connect with PR server 100 through the Internet or through a dial-up direct connection. One example of a dial-up direct connection is the i-Mode® service offered by NTT DoCoMo® in Japan. A cellular subscriber to such service can connect, via a service menu choice on his cellular phone to an i-mode server to use various kinds of service menu programmed/operated by NTT DoCoMo®.

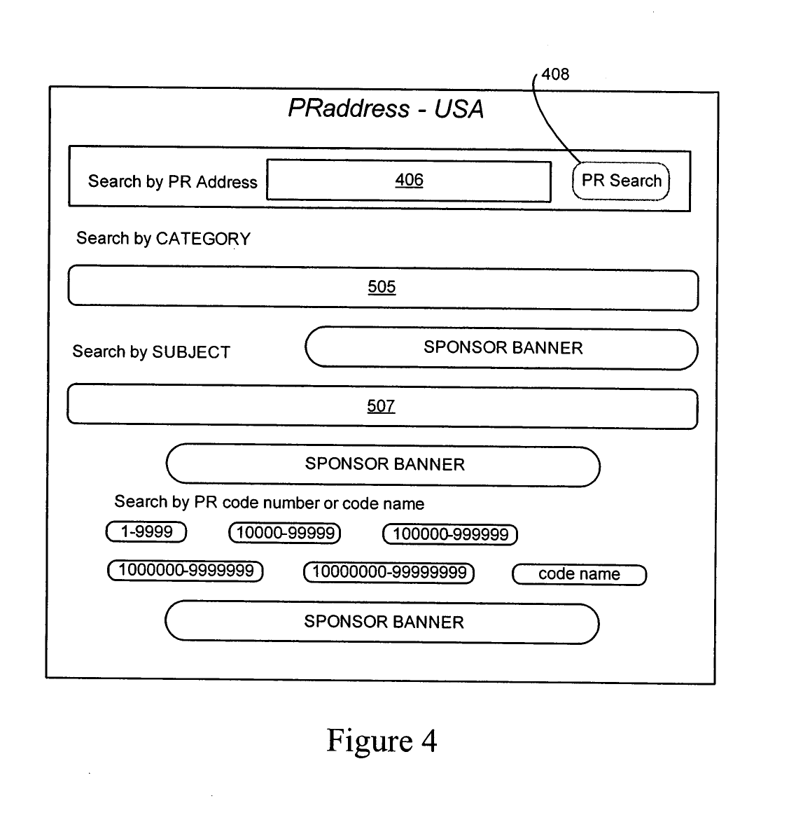

FIG. 4 is a schematic diagram of an exemplary web page used by a PC/Notebook user with a DIRECT connection to PR server 100. It is possible to directly connect to the PR server using a network associated with the PR system. The PR system can thus provide access to all search engines and web pages directly to those without other access. Using such a connection, an IR can obtain PR Information in a automated return email or by viewing by a message box on a screen.

The email addressing scheme described above is not the only manner in which email addresses can be composed and utilized. Alternative email addressing schemes can and should be used when there are technical incompatibilities among the various systems that must communicate. For example, consider an IR user who wants to access the PR system to look for a job in New York City at an ABC Hamburger Shop. There are various ways to find the information sought.

a If the IR user is a PC user with an Internet connection, he can point his browser directly to the homepage of PR server 100, namely www.PRaddress.com.

b If the IR user is a cellular customer with an Internet connection, he can access the PRaddress.com web page formatted for the small screen of a cellular phone, for example WAP formatted page through the Internet.

If the IR user is a cellular customer without an Internet connection, the IR can access a PRaddress.com web page designed for non-Internet users using an available text based message service, such as SMS, instant messaging, etc. The IR can send an email inquiry to the PR system in order to retrieve information. For example the IR can address a blank email to: job@abch.nyc.PRaddress.com or job@10234.nyc.PRaddress.com. The PR server would, in response to such email, send a reply email containing the desired information about job availability of ABC hamburger in NYC.

The easiest way to use our PR system is to access directly to PR server 100. PR server 100 has associated with it an independent PR service system. This service system has its own access numbers to communicate compatibly with various types of users, such as PC users, cellular phone users, PHS users, PDA users, etc. whether or not they have Internet access.

As explained with respect to FIG. 3 (314, 315, 316,) the PR system is able to provide services without using the Internet by having available dial-up direct connection access. PRaddress.com will utilize this dial-up connection by having a service program of PR system as one of service menu (charge or at free of charge operated by Cellular Phone Carriers, PDA/Palms/Blackberry/PHS and other data wireless communication Carriers, Cable/Fiber Cable/Satellite Carries, ISPs ADSL, DSL, Dial-up, AOL® and Search engine Companies. Then PRaddress.com doesn't need to invest to set up hundreds of access point for dial-up direct connection by utilizing above existing facilities.

By providing a direct connection network, the PR system can be accessed as a service menu choice provided by an affiliate, such as a cellular carrier, etc. For example, NTT Docomo®, a large cellular carrier in Japan, can offer PR server access as a service menu option of it's “i-mode” service. Similarly, Sprint could offer our PR server information as a menu choice to its customers. Thus, a cellular user, such as an NTT customer who has a cellular phone with i-mode function can access to our PR server directly without Internet connection. Large cellular carriers already have this kind of service (i-mode® or something similar will soon launch).

In order to provide universal service, PR server 100 has stored a plurality of web pages grouped for various kinds of users:
PC user
cellular phone users (WAP format, etc.
various data communication terminals with Internet access
users of text message services, such as SMS
PR menu users with direct access.

Software that includes information about how to use the PR system and that provides search templates, etc is distributed to potential IRs in a number of ways: CD-ROM, DVD-ROM, download via the Internet, via cellular carriers, etc.

Inventions defined by the claims have been described above partially by providing specific examples. The examples are just that—examples. They are not meant to represent the only way to practice the claimed inventions. Rather, they are included to help the reader understand the principles of the inventions.

1. An information system with which information providers (IP) disseminate information to information recipients (IR) with or without the need for any IR to disclose his identity, comprising:
an information server for storing and dispensing information;
means for allowing a IP to upload information to the information server which is stored therein as data;
means for receiving an information request from an IR indicating that the IR desires a particular kind of information;
means for searching data stored in the information server and retrieving information requested by the IR; and
means for sending retrieved information to the IR.

2. A system according to claim 1 wherein:
the means for receiving an information request comprises means for receiving an email message sent to the information server by an IR; and
the means for sending retrieved information to the IR comprises means for sending an automated email reply message to the IR.

3. A system according to claim 1 wherein:
the means for receiving an information request comprises means for receiving an information request via an Internet browser interface; and
the means for sending retrieved information to the IR comprises means for sending retrieved information via an Internet browser interface.

4. A system according to claim 1 wherein:
the means for receiving an information request comprises means for receiving an information request via a text messaging system associated with a cellular carrier; and
the means for sending retrieved information to the IR comprises means for sending retrieved information via a text messaging system associated with a cellular carrier.

5. A system according to claim 1 wherein:
the means for receiving an information request comprises means for receiving an information request via a packet data system; and
the means for sending retrieved information to the IR comprises means for sending retrieved information via a packet data system.

6. A system according to claim 1 wherein information uploaded by an IP to the information server is organized into a plurality of “subjects” and an information request from an IR specifies at least one subject of information to be retrieved.

7. A system according to claim 2 wherein information uploaded by an IP to the information server is organized into a plurality of “subjects” and an information request from an IR specifies at least one subject of information to be retrieved.

8. A system according to claim 7 wherein the subject of information requested is indicated by a portion of the “To” address of the email sent by the IR.

9. A system according to claim 1 wherein each IP is assigned a code identifier by the system.

10. A system according to claim 9 wherein an IP whose information is sought by an IR is indicated by including the code identifier as a portion of the “To” address of the email sent by the IR.

11. A system according to claim 2 wherein the email message reply to the IR includes a banner sponsor message.

12. A system according to claim 3 wherein a banner sponsor message is included with the information retrieved and sent to the IR.

13. A system according to claim 1 further comprising:
means for affiliating a code identifier to each IP;
means for assigning a category with which each IP is affiliated;
means for organizing information uploaded to the information server by each IP into a plurality of “categories”; and
wherein the means for searching includes means for searching for information related to an IP affiliated with a particular code identifier.

14. A method of distributing information, comprising: uploading information to an information server from an information provider (IP);
organizing the information collected from the IP and storing it as data on the information server;
receiving an information request from an information receiver (IR) indicating that he wants a particular kind of information;
searching data stored in the information server and retrieving information requested by the IR; and
sending retrieved information to the IR.

15. A method according to claim 14 wherein:
the receiving of an information request comprises receiving an email message sent to the information server by an IR; and
the sending retrieved information to the IR comprises sending an automated email reply message to the IR.

16. A method according to claim 14 wherein:
the receiving an information request comprises receiving an information request via an Internet browser interface; and
the sending retrieved information to the IR comprises sending retrieved information via an Internet browser interface.

17. A method according to claim 14 wherein:
the receiving an information request comprises receiving an information request via a text messaging system associated with a cellular carrier; and
the sending retrieved information to the IR comprises sending retrieved information via a text messaging system associated with a cellular carrier.

18. A method according to claim 14 wherein:
the receiving an information request comprises receiving an information request via a packet data system; and
the sending retrieved information to the IR comprises sending retrieved information via a packet data system.

19. A method according to claim 14 wherein:
information uploaded by an IP to the information server is organized into a plurality of “subjects”; and
an information request from an IR specifies at least one subject of information to be retrieved.

20. A method according to claim 15 wherein:
information uploaded by an IP to the information server is organized into a plurality of “subjects”; and
an information request from an IR specifies at least one subject of information to be retrieved.

21. A method according to claim 20 wherein the subject of information requested
is indicated by a portion of the addressee of the email sent by the IR.

22. A system according to claim 13 further comprising means for assigning a code
identifier to an IP.

23. A method according to claim 22 wherein an IP whose information is sought by an IR is indicated by including the code identifier as a portion of the addressee of the email sent by the IR.

24. A method according to claim 15 further comprising including a banner sponsor message with the email message reply to the IR.

25. A method according to claim 16 further comprising including a banner sponsor message with the information retrieved and sent to the IR.

26. A method according to claim 14 further comprising:
affiliating a code identifier to each IP;
assigning a category with which each IP is affiliated;
organizing information uploaded to the information server by each IP into a plurality of “subjects”; and
wherein the searching includes searching for information related to IPs that are affiliated with the code identifier.

27. A method according to claim 26 further comprising:
providing access to the information server via a service menu of a cellular carrier.

28. A method according to claim 26 further comprising:
providing access to the information server via a service menu of a packet data carrier.

29. A method according to claim 26 further comprising:
providing access to the information server via a service menu of a cable network.

30. A method according to claim 26 further comprising:
providing access to the information server via a service menu of a satellite network.

31. A method according to claim 26 further comprising:
providing access to the information server via a service menu of an Internet Service Provider (ISP).

32. A method according to claim 26 wherein an information request by an IR includes the code identifier of an IP whose subject information is sought and one or more subject identifiers of the information sought from the IP and wherein the sending of retrieved information includes information from the IP corresponding to the code identifier the information including the IP's information related to the “subjects” indicated in the IR's information request.

33. A method according to claim 26 further comprising:
publishing an address book of IPs including for each IP at least the IP's name, code identifier and affiliated category.
